(19) United States
(12) Patent Application Publication
(10) Pub. No.: US 2016/0124964 A1
(43) Pub. Date: May 5, 2016

(54) METHODS FOR UPLOADING AND RANKING PHOTOGRAPHS

(71) Applicant: PIXCON, Cali (CO)

(72) Inventor: Juan Manuel Correa Caicedo, Cali (CO)

(21) Appl. No.: 14/582,759

(22) Filed: Dec. 24, 2014

Related U.S. Application Data
(60) Provisional application No. 62/073,303, filed on Oct. 31, 2014.

(51) Int. Cl. G06F 17/30

(52) U.S. Cl. CPC G06F 17/3053; G06F 17/30867; G06F 17/30528; G06F 17/30345; G06F 17/30554

(57) ABSTRACT

System and methods allow participants to upload their best photographs and determine what other participants around the world think of them. As a non-limiting example, the present invention can be a system and associated methods in a social networking app. A participant is anyone who downloads the app.

### CROSS-REFERENCE TO RELATED APPLICATIONS

This application claims the benefit of U.S. Provisional Patent Application No. 62/073,303, filed Oct. 31, 2014, entitled “Systems and Methods for Uploading and Ranking Photographs,” Attorney Docket No. 47961-501P01US, for which application is fully incorporated herein by reference.

### BACKGROUND

1. Field of the Invention

The present invention relates generally to social networks, and more particularly to methods that use streaming in the ranking of photography.

2. Brief Description of the Related Art

Online social networks connect users with common interests to each other. Social networking sites such as Facebook® and the like foster relationships between their members, thereby offering a higher level of affiliation and trust than other online media through which users can interact with each other such as electronic message boards or forums.

These and other social networks have witnessed tremendous growth by offering users unique opportunities for self-expression, socialization, and the distribution of user-made content. The proliferation of social network objects such as users, communities, postings, and other forms of content, however, has exacerbated the challenge of identifying relevant and high-quality content.

Existing search interfaces within social networks leave much to be desired. While results may be returned based on word matches or user ratings, for instance, other ways to assess the importance or quality of objects found is generally lacking. As a result, a user may be required to view many low-quality and unwanted items before finding a social network object of interest.

Conventional methods of ranking photography, e.g., photographs, have their shortcomings when applied to social networks. They generally rely solely on measures of value extrinsic to an online social network such as the location and frequency of keywords on a particular page. These metrics, however, do not by themselves reflect the value of an object in a social network.

There is a need for improved systems and methods for ranking photographs.

### SUMMARY

An object of the present invention is to provide methods that use probability distributions to assign probabilities to elements that appear in a stream.

Another object of the present invention is to provide methods that create photograph competitions in which all participants are both juries and competitors.

A further object of the present invention is to provide methods that create photograph ratings.

Yet another object of the present invention is to provide methods that provide for recognition of photograph ratings.

These and other objects of the present invention are achieved in a method for ranking photographs. At least one computer system is used with at least one processor. A ranking algorithm is executed by the processor. A score is assigned for one or more photographs, with the score being correlated to a number of votes that a photograph has received from third party participants. The ranking algorithm determines at least one of: a number of times a photograph has been saved, shared or screenshot, a number of visits to an uploader's profile the photograph has generated, and a number of flips third parties have given the photograph. The score for a photograph is inversely correlated to a number of times it has been displayed.

### BRIEF DESCRIPTION OF THE DRAWINGS

FIGS. 1 and 2 illustrate an embodiment of the present invention where a set S of photographs has been uploaded to the system.

FIG. 3 illustrates an embodiment of the present invention where after probabilities are calculated as then assigned to each photograph.

FIG. 4 illustrate a first screen seen by a participant that appears once after the participant presses an icon of the application on a mobile device suitable device.

FIG. 5 illustrates additional displays of photos and screens that can be created by the system of the present invention.

FIG. 6 illustrates an embodiment of the present invention of a display where of a photograph displayed for a certain length of time with fade-in/fade-out.

FIG. 7 illustrates a display created by the system of the present invention which includes the number of votes received by the photograph in the display.

FIG. 8 illustrates an embodiment of the present invention illustrating that when a flip bottom is depressed the participant then goes to a photograph description screen.

FIG. 9 illustrates an embodiment of the present invention of an image description screen.

FIG. 10 illustrates an embodiment of the present invention of a menu screen where a “send Pic” takes one to a system's camera and allows a participant to send a photograph to the stream.

FIG. 11 illustrates one embodiment of a photographer's profile.

FIG. 12 illustrates an embodiment of present invention where the photographer's qualitative description is calculated on a selected number of day intervals.

FIG. 13 illustrates an embodiment of the present invention when the jury's rank changes the photographer receives a notice is this change.

FIGS. 14(a)-(e) illustrate an embodiment of a cloud infrastructure that can be utilized with the present invention.

FIGS. 15A-15C are diagrams illustrating embodiments of a mobile or computing device that can be used with the present invention.

FIG. 16 is a system diagram of one embodiment of an environment in which the invention may be practiced.

FIG. 17 shows one embodiment of a mobile device that may be included in a system implementing the invention.

FIG. 18 shows one embodiment of a network device that may be included in a system implementing the invention.

FIG. 19 illustrates a logical flow diagram generally showing one embodiment of a process for managing social networking information, including vitality information for social networking members.

FIG. 20 illustrates a logical flow diagram generally showing one embodiment of a process for enabling a mobile virtual hang-out space using a live contact list of a social network member activities based, at least in part, on vitality information.

FIG. 21 is diagram of a computer-based system according to various embodiments of present invention for prioritizing photographs.

FIG. 22 is a flowchart depicting a process for prioritizing the photographs.

### DETAILED DESCRIPTION

In one embodiment of the present invention systems and methods are provided that where ranking scores are assigned to photographs that are posted. In one embodiment the posting is via Network Systems. In another embodiment the postings are via social media.

In one specific embodiment each photograph has a score that is determined according to a ranking algorithm. The ranking algorithm is used to rank elements in an order, and then assigns probabilities based on any probability distribution.

In one embodiment of the present invention systems and methods are provided that use streaming in the ranking of photography, photographs, in social networks.

The system and method of the present invention allow participants to upload their best photographs and determine what other participants around the world think of them. As a non-limiting example, the present invention can be a system and associated methods in a social networking app. A participant is anyone who downloads the app.

In one embodiment, the participants are both juries and competitors. In one embodiment the photos appear in a stream. Each participant sees and ranks at least a selected number of photographs before uploading one of their own. As a non-limiting example, the number can be three.

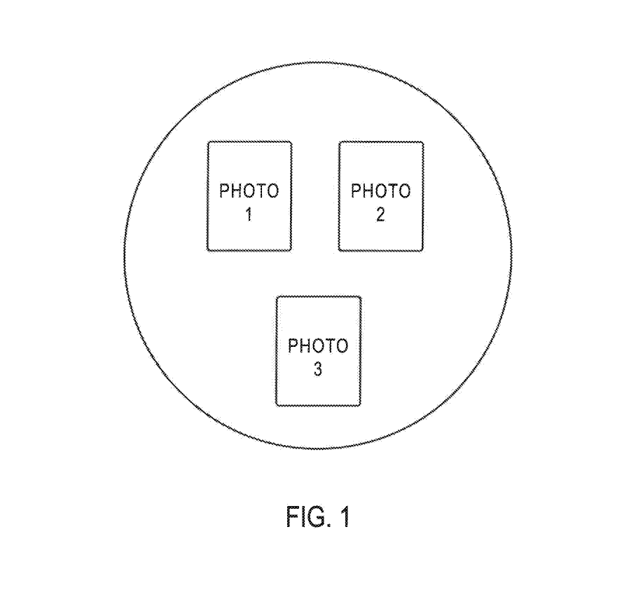

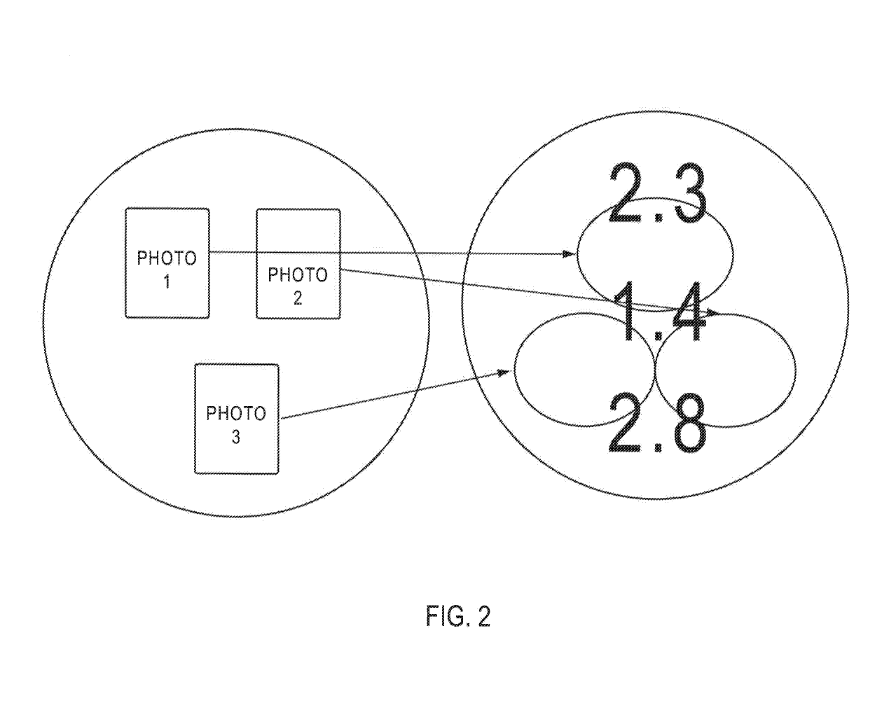

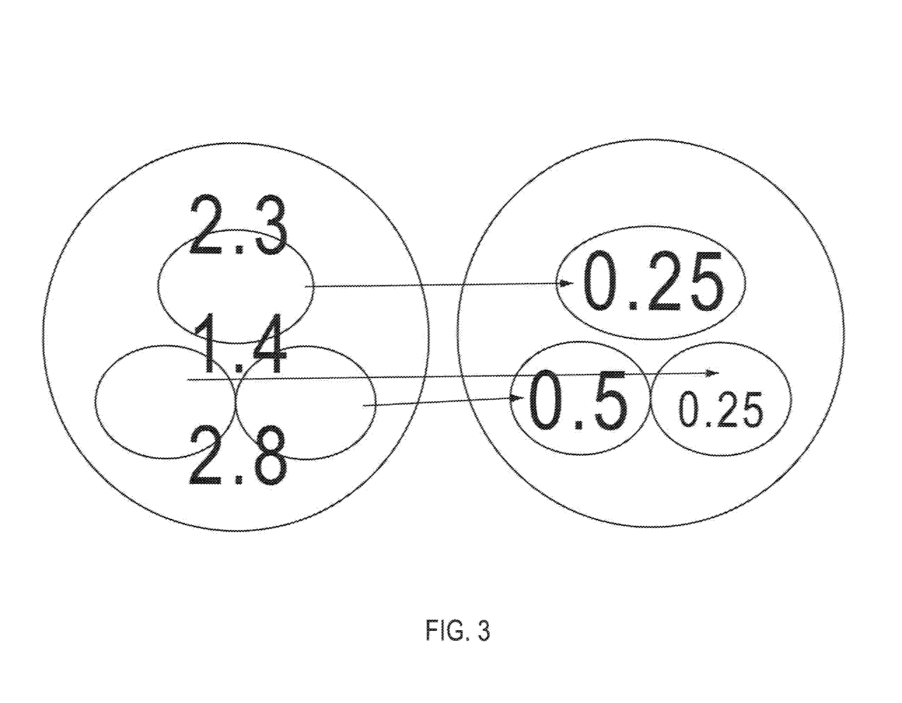

In one embodiment, illustrated in FIGS. 1 and 2, a set S of photographs has been uploaded to the system. Each photograph has a score that is determined according to a ranking algorithm. The ranking algorithm is used to rank elements in an order, and then assigns probabilities based on any probability distribution.

In one embodiment, every picture is assigned a score that is directly correlated to the number of votes it has received, the number of times it has been saved, shared or screenshot, the number of visits to the uploader's profile it has generated and the number of flips people have given it, and that is inversely correlated to the number of times it has been displayed. These scores are in a set D. In another set, R, there are several probability values in a probability distribution, all of which add up to 1 (100%). Both sets D and R are ordered, from the biggest element to the smallest. An ordering embedded function is performed (a function that preserves the orders on both sets) from R to D. The elements that are assigned probabilities have that probability of appearing in the stream when a user is on the app.

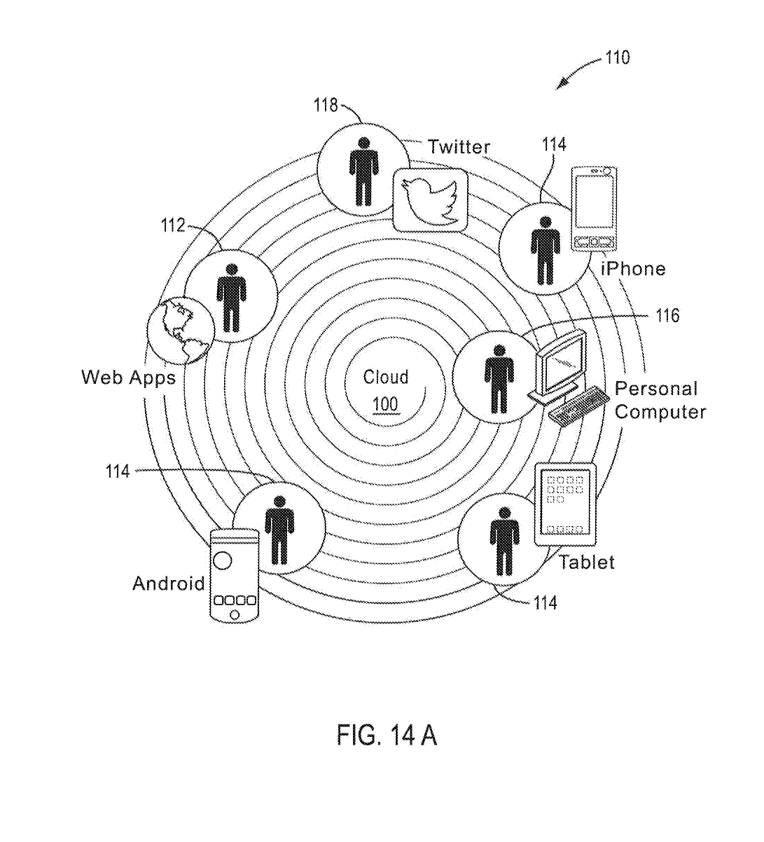

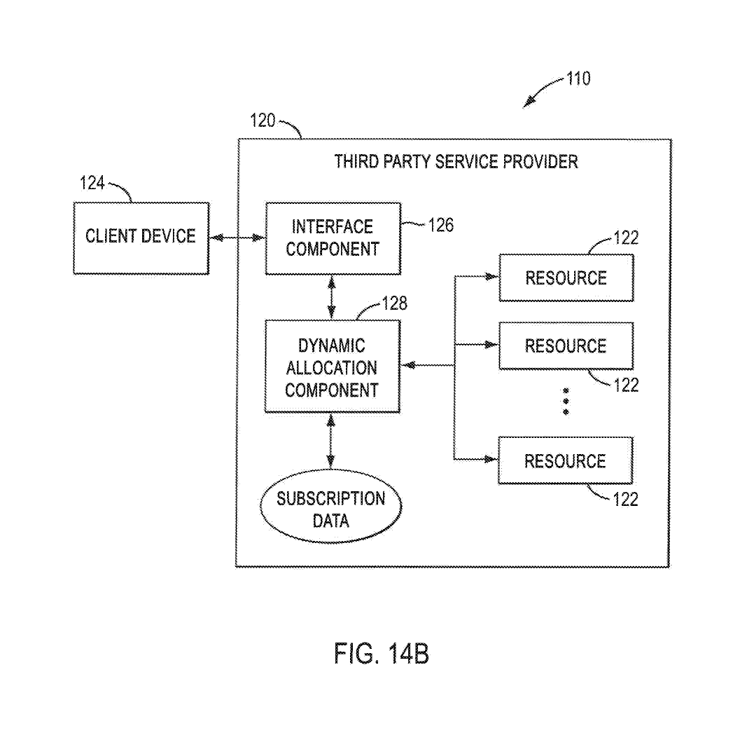

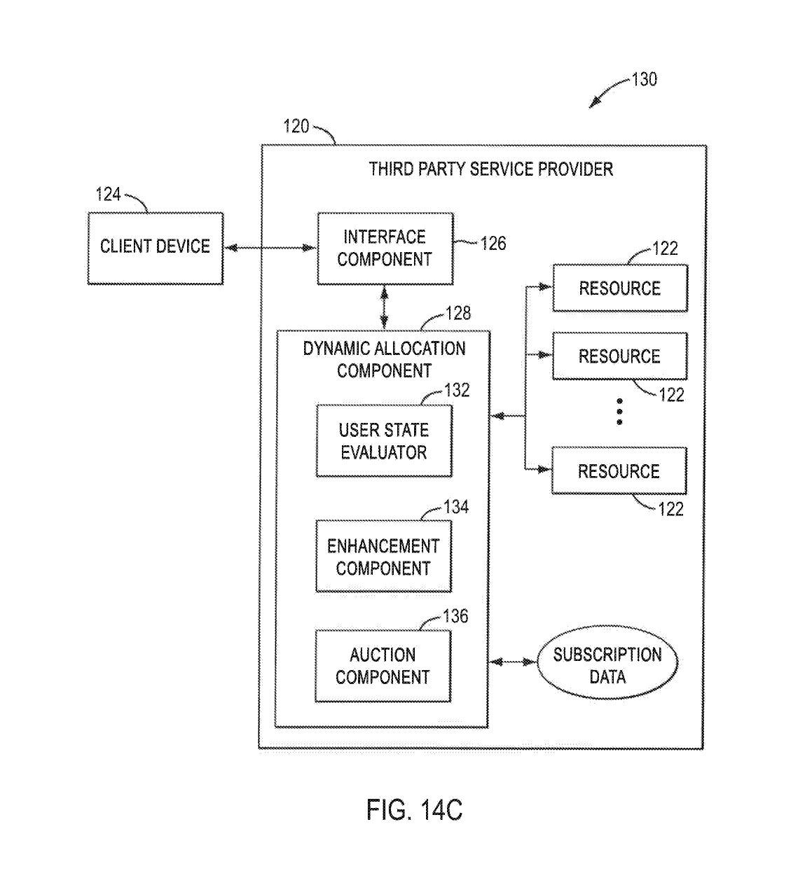

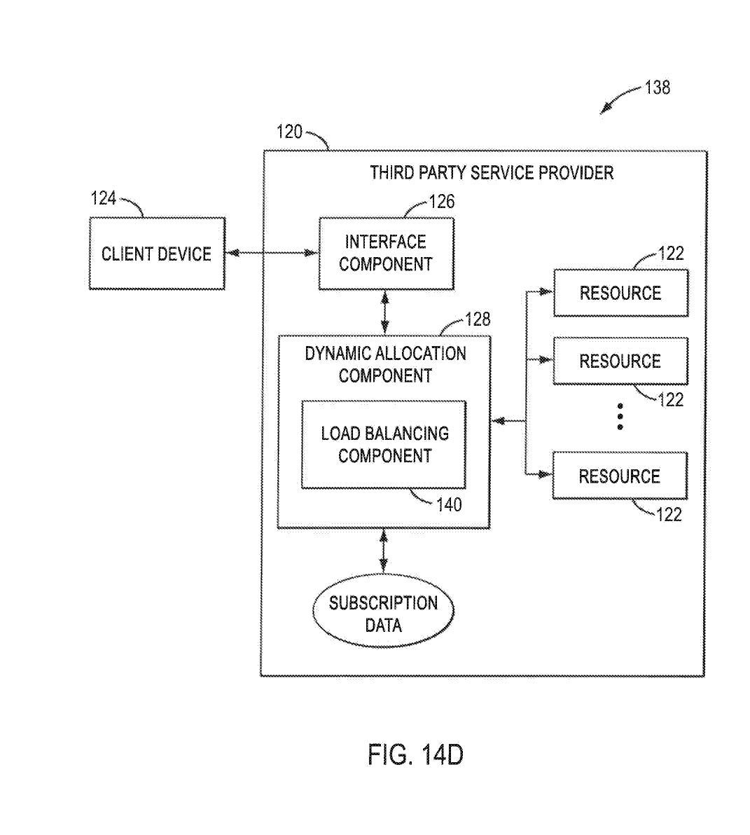

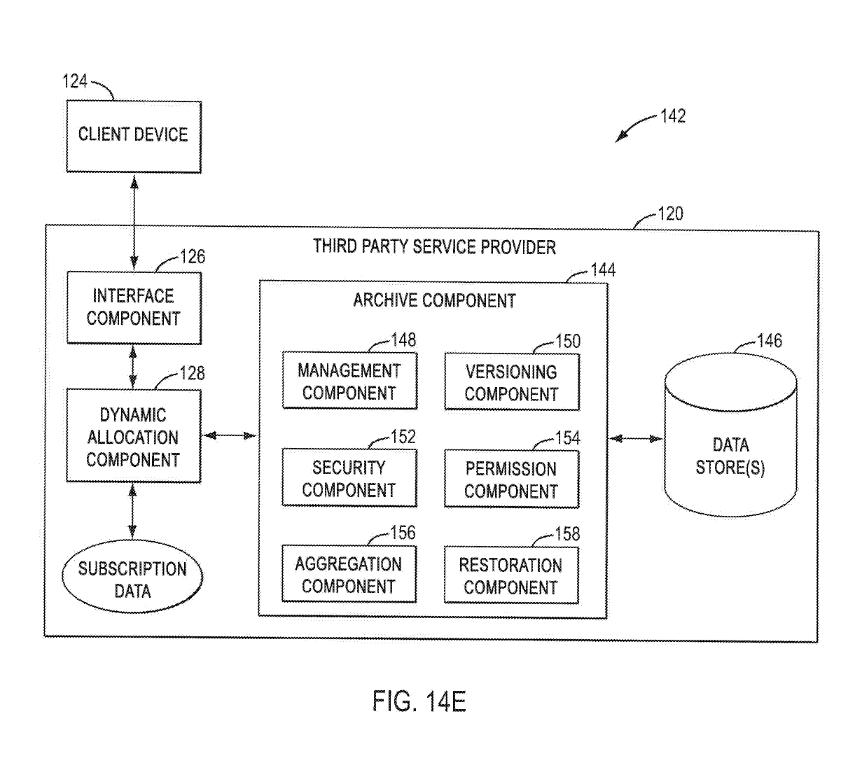

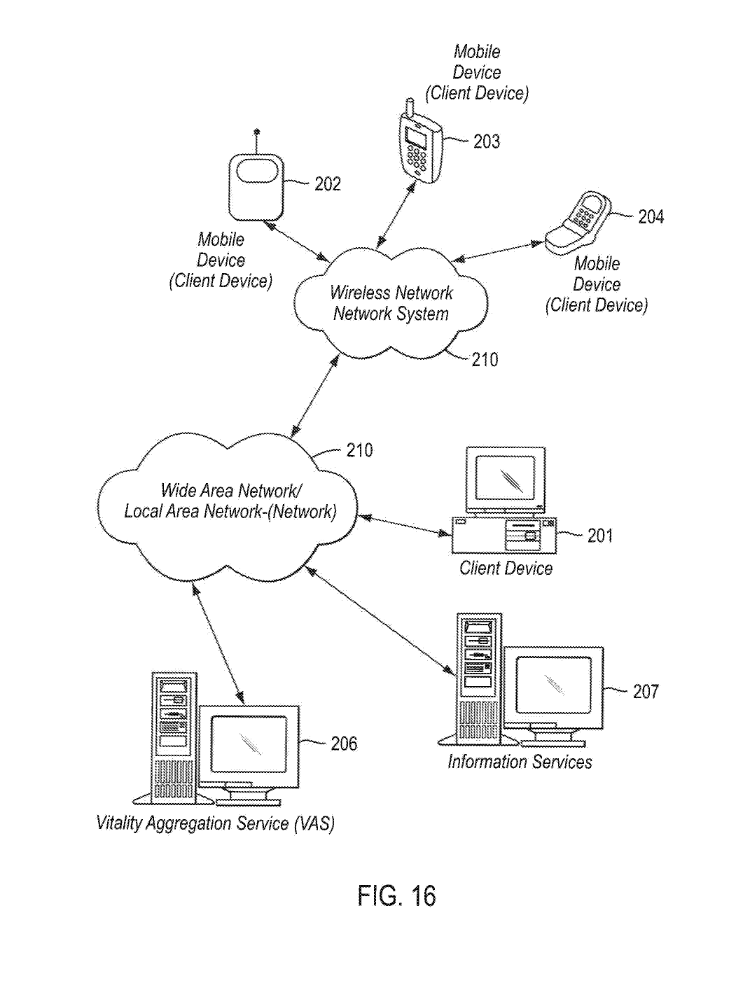

In one embodiment the following ranking algorithm is executed in the cloud, as illustrated in FIGS. 14(a)-(e) and via FIGS. 16 through 21.

$$d = number of times the picture has been displayed on any phone$$

$$V = Visits to the uploader ' s profile the photo has generated$$

$${P}_{t} = number taps the photo got while paused$$

$$F = number of flips$$

$$S = n umber of times the element has been saved or shared or$$

$$screenshot$$

$$T = numbers of taps the photo has received$$

$$x = {a}_{1} S + {a}_{2} V + {a}_{3} F + {a}_{4} {P}_{t} + {a}_{5} T$$

$$f ( d , x ) = {e}^{( - d + {( x )}^{{a}_{6}} )}$$

$$D = \{ p \vert f ( d , x ) \}$$

$$R = \{ q \vert ( \begin{matrix}{a}_{7} \\ k\end{matrix} ) ( {a}_{8}^{k} ) ( {a}_{9}^{{a}_{7} - k} ) , k ∈ ℕ , k \leq {a}_{7} \}$$

$$g : D \to R h : R \to D$$

$$Where : \\ D and R are sets$$

$$g is a function from D to R$$

$$h is a function from R to D$$

$$All {a}_{i} are constants or variables that meet the following conditions \text{:}$$

$${a}_{i} ∈ ℂ$$

$${a}_{8} > 0$$

$${a}_{9} > 0$$

$${a}_{8} + {a}_{9} = 1$$

In another embodiment the following ranking algorithm is used:

$$d = number of times the picture has been displayed on any phone$$

$$V = Visits to the uploader ' s profile the photo has generated$$

$${P}_{t} = number taps the photo got while paused$$

$$F = number of flips$$

$$S = number of times the ele ment has been saved or shared or$$

$$screenshot$$

$$T = numbers of taps the photo has received$$

$$x = 100 S + 100 V + 50 F + 2 {P}_{t} + T$$

$$f ( d , x ) = {e}^{( - d + {( x )}^{\frac{11}{20}} )}$$

$$\vert D \vert = number of pictures in the data base ( cardinality of D )$$

$${n}_{w} = TOTAL number of pictures that have been displayed$$

$$in the last 7 days$$

$$Ω \{ \begin{matrix}100 < \vert D \vert < \frac{{n}_{w}}{7} \to Ω = \vert D \vert \\ \vert D \vert \geq \frac{{n}_{w}}{7} > 100 \to Ω = \frac{{n}_{w}}{7} \\ \frac{{n}_{w}}{7} \leq 100 \vert D \vert \leq 100 \to Ω = \vert D \vert \\ \frac{{n}_{w}}{7} \leq 100 \vert D \vert > 100 \to Ω = 100\end{matrix} \\ D = \{ p \vert f ( d , x ) , p \neq 0 \} \\ R = \{ q \vert ( \begin{matrix}Ω - 1 \\ k\end{matrix} ) ( {0.5}^{k} ) ( {0.5}^{( Ω - 1 ) - k} ) , k ∈ ℕ , k \leq ( Ω - 1 ) \}$$

In one embodiment the photographs in a set S are assigned a score that is determined according to the preceding algorithm. Scores of the photographs are in a set D. All the scores in set D are ordered from highest to lowest, and they are assigned a position i.e. first, second etc. The new photographs will always have a score of one. Once set D is ordered, the position of the last photograph with a score of one is taken. Call this position n.

The probability that a photograph will appear in any given frame in the stream is determined by a binomial distribution with a probability of success of 0.5 and a number of trials equivalent to the position of the last value of 1 in set D (once set D is ordered) multiplied by 2, minus 1, that is, 2n−1. As a non-limiting example, a suitable binomial distribution is:

$$R = \{ q \vert ( \begin{matrix}\vert D \vert - 1 \\ k\end{matrix} ) ( {0.5}^{k} ) ( {0.5}^{( \vert D \vert - 1 ) - k} ) , k ∈ ℕ , k \leq ( \vert D \vert - 1 ) \}$$

Where each term of the binomial expansion is in set R.

Referring now to FIG. 3, after the probabilities are calculated they are then assigned to each photograph. The photograph with the highest score has the greatest probability of winning. The one with the second highest score has the second probability and so on. The calculation can be achieved with the following:

$$D = \{ p \vert f ( t , w , x , y , z ) , p \neq 0 \}$$

$$R = \{ q \vert ( \begin{matrix}\vert D \vert - 1 \\ k\end{matrix} ) ( {0.5}^{k} ) ( {0.5}^{\vert D \vert - k} ) , k ∈ ℕ , k \leq ( \vert D \vert - 1 ) \}$$

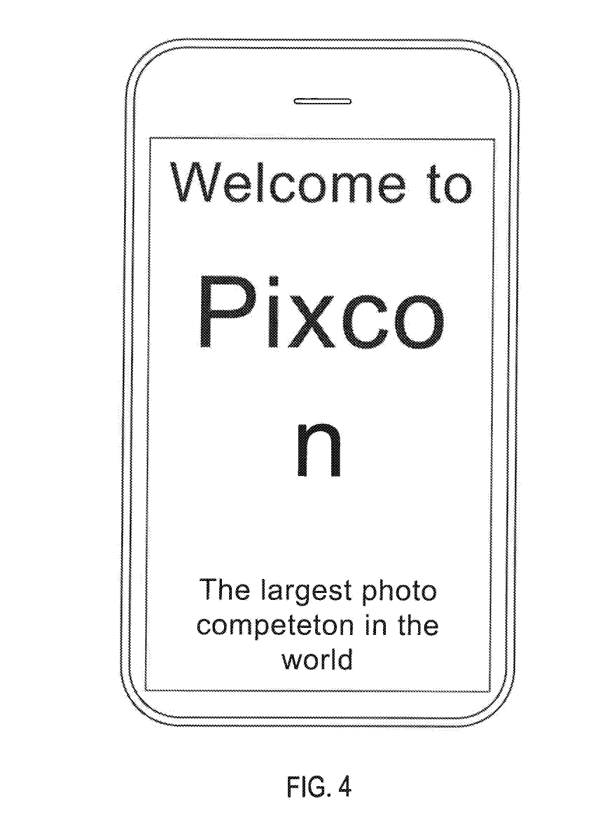

In one embodiment, illustrated in FIG. 4, the first screen seen by a participant appears once after the participant's presses an icon of the application on a suitable device, including but not limited to a mobile device.

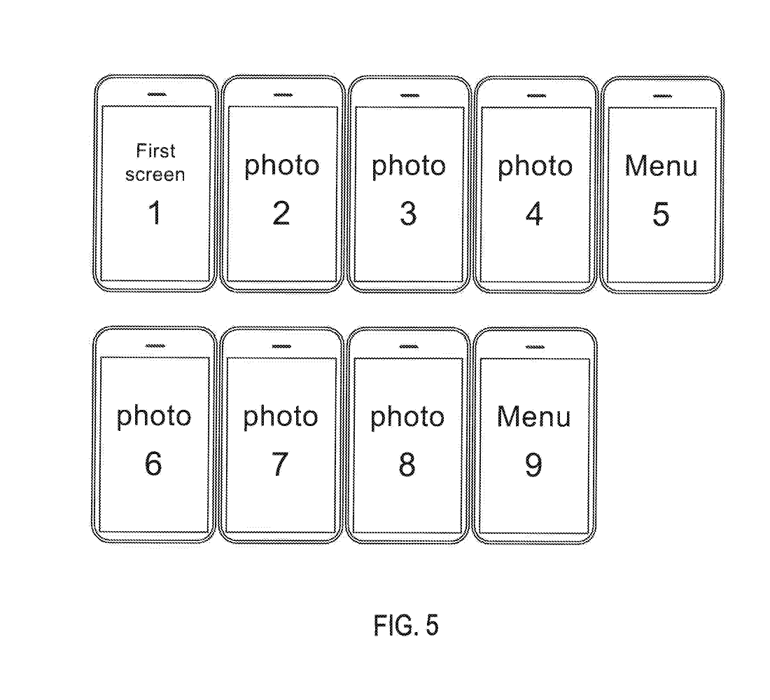

FIG. 5 illustrates additional displays of photos and screens.

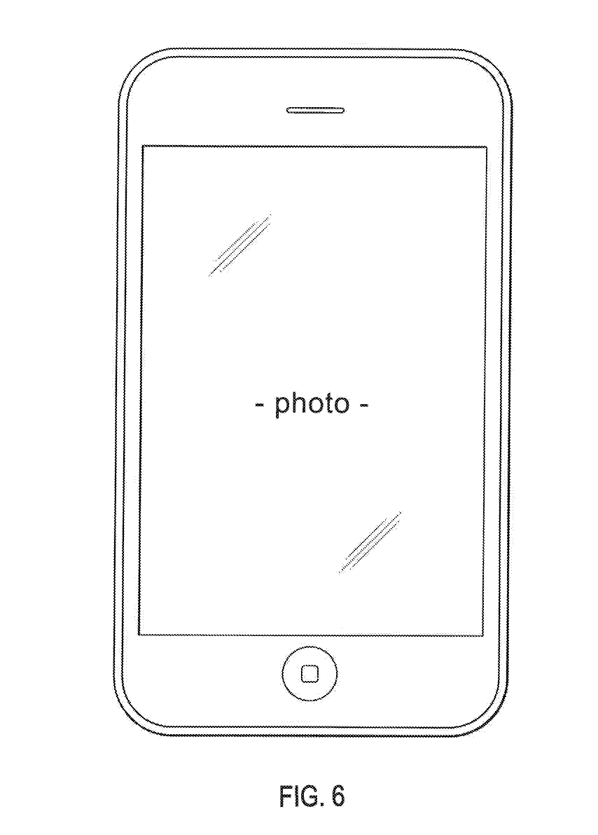

In one embodiment each photograph is displayed for a certain length of time. As a non-limited example this can be seven seconds. A transition can be at least one second and then a fade-in/fadeout is provided as illustrated in FIG. 6. Fading in and out provides a transition function that is aesthetic for streaming.

As non-limiting examples the system and method utilize a number of commands including but not limited to: tapping a touch screen to vote for a photograph, noting that one can vote for a photograph as many times as one likes; pressing and holding the touch screen pauses the stream, and after it is paused the participant can continue to vote, pressing and holding the touch screen again plays the stream once more.

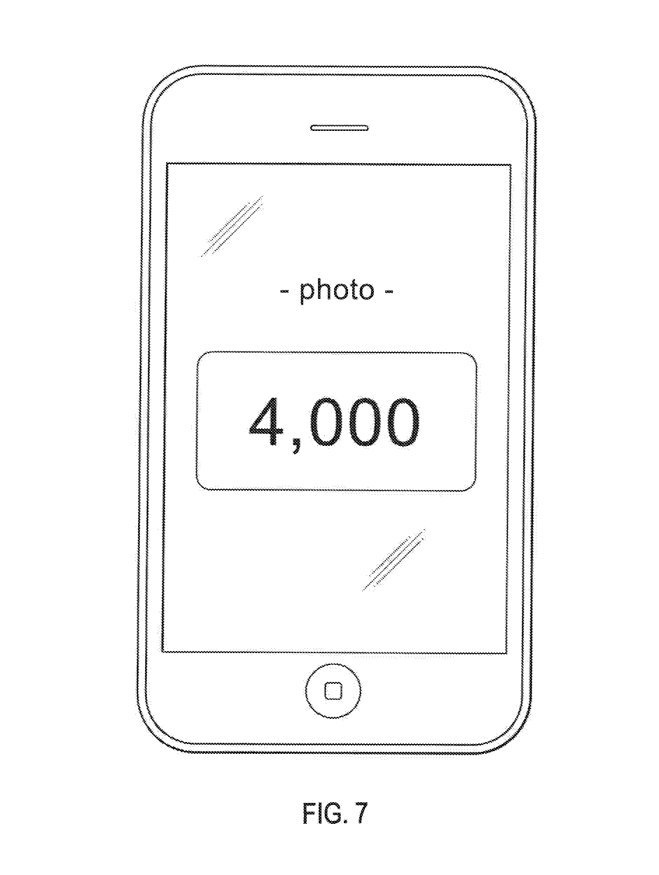

Referring now to FIG. 7, when one votes for a photograph the participant is then able to see the number of votes the photograph has. This number is updated with every newly cast vote. The number of votes displayed on the photograph does not eat away from the number of seconds that the photographs remains on the screen but adds to that number, e.g, the act of voting does not take away from the amount of time it is displayed.

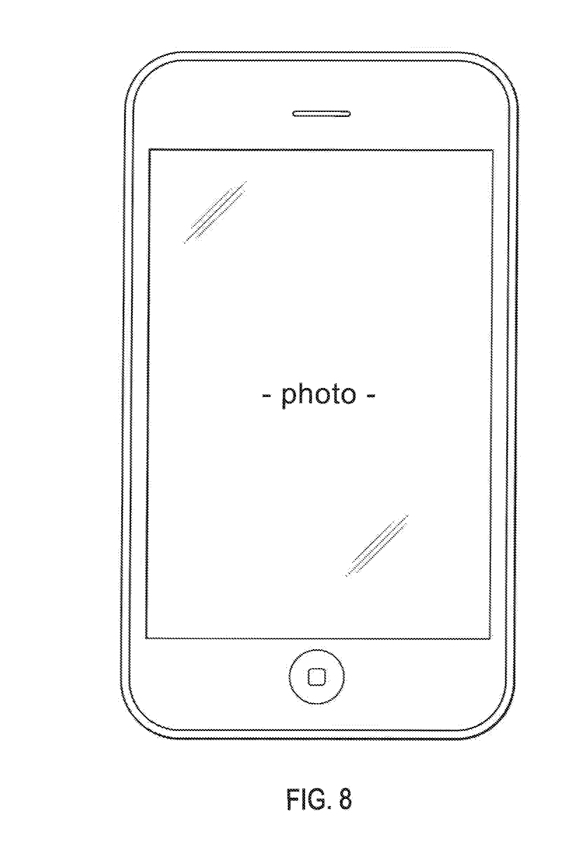

When a participant pauses the stream a flip bottom appears. When the flip bottom is depressed the participant then goes to a photograph description screen, see FIG. 8.

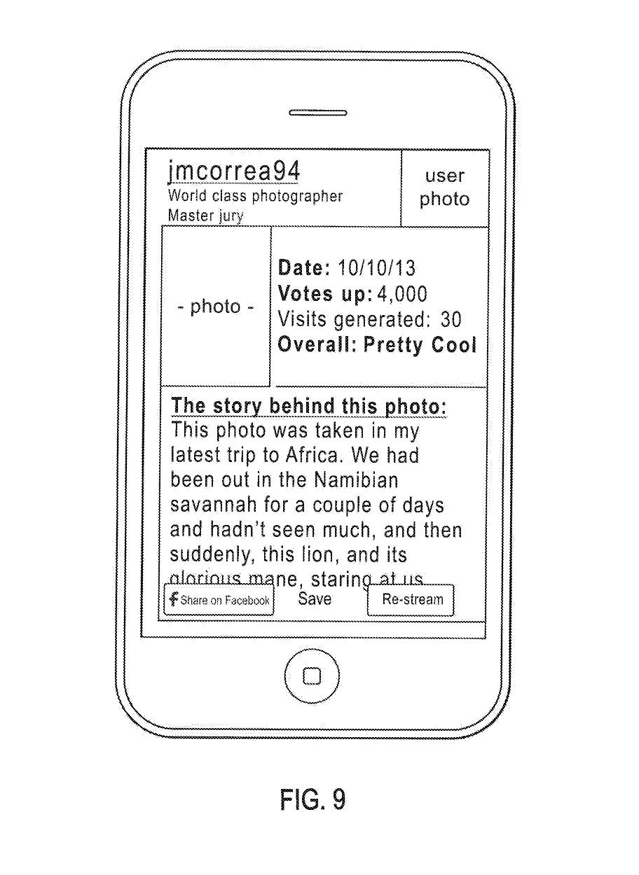

As illustrated in FIG. 9, an image description screen is provided. A participate can press the flip button again to return to the stream. When the participant presses the name of the photographer one then goes to that photographer's profile and votes up shows the number of votes the photograph has. As a non-limiting example, a visits generated shows how many participants have visited the profile of the photographer in response to that particular photo. An overall quantitative description of the photograph and the qualitative descriptions of the participant as a jury as a photographer depends on variable described hereafter.

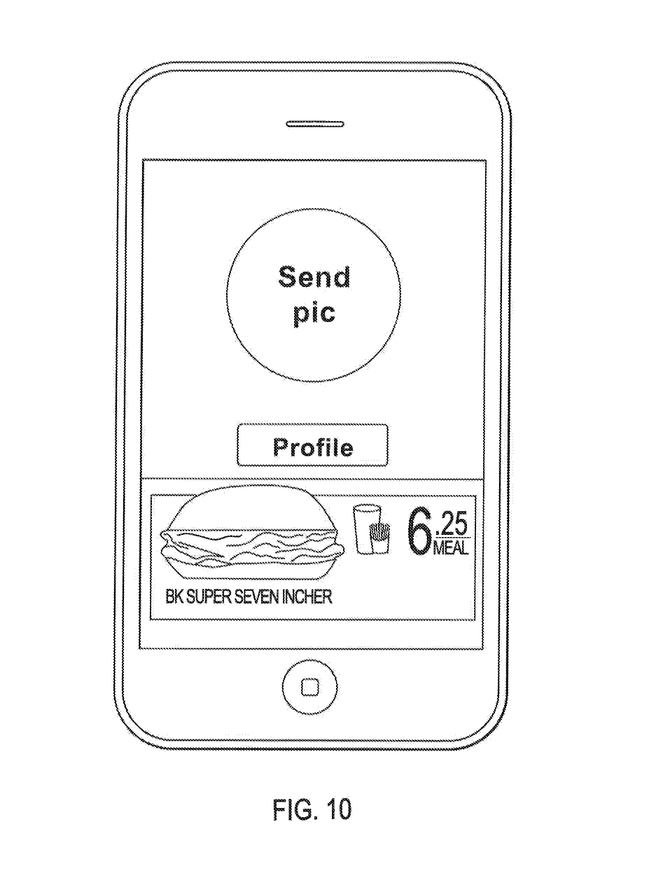

FIG. 10 illustrates a menu screen where a “send Pic” takes one to the system's camera and allows a participant to send a photograph to the stream. Advertisements can be displayed here.

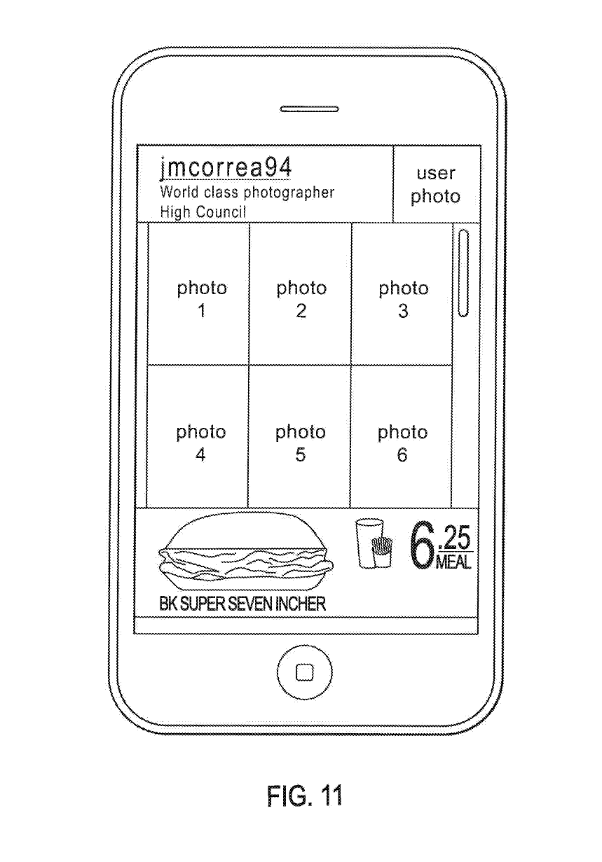

FIG. 11 illustrates one embodiment of a photographer's profile. In one embodiment a participant can view any photos the photographer has ever loaded and allows a participant to vote for them, see their description, and the like. Advertisements can also be displayed as well as other things desired by the photographer.

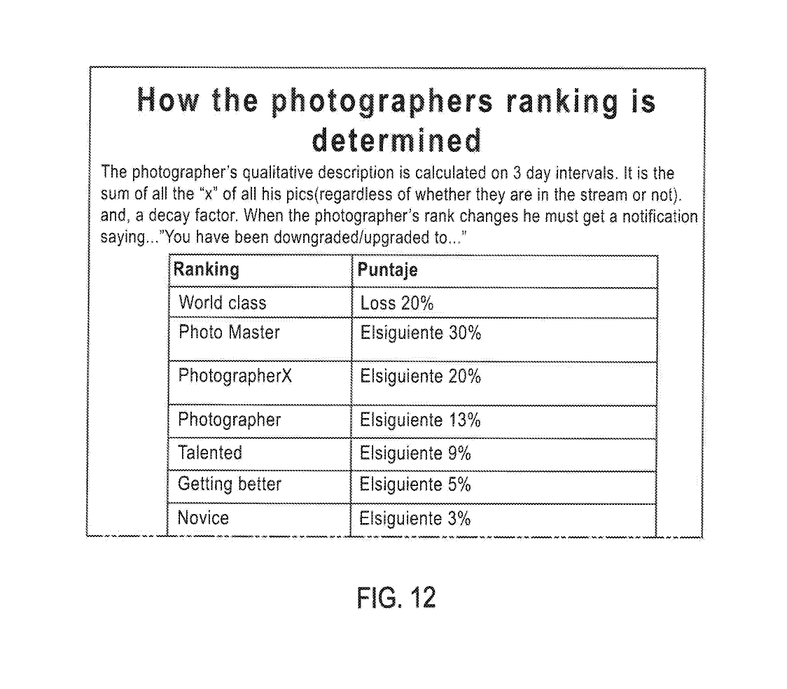

As a non-limiting example, and as illustrated in FIG. 12, the photographer's qualitative description is calculated for, as a non-limiting example, three day intervals. In one embodiment the calculation is the sum of the number of photos irrespective of whether they are in the stream or not. A decay factor is also used. When the photographer's rank changes the photographer receives notification of the change of status.

As a non-limiting example, the sum of the photographer's x's and decay factors can be determined as follows:

$${e}^{( \frac{- t}{604800} )} \times {\sum }_{i = 1}^{n} {x}_{i}$$

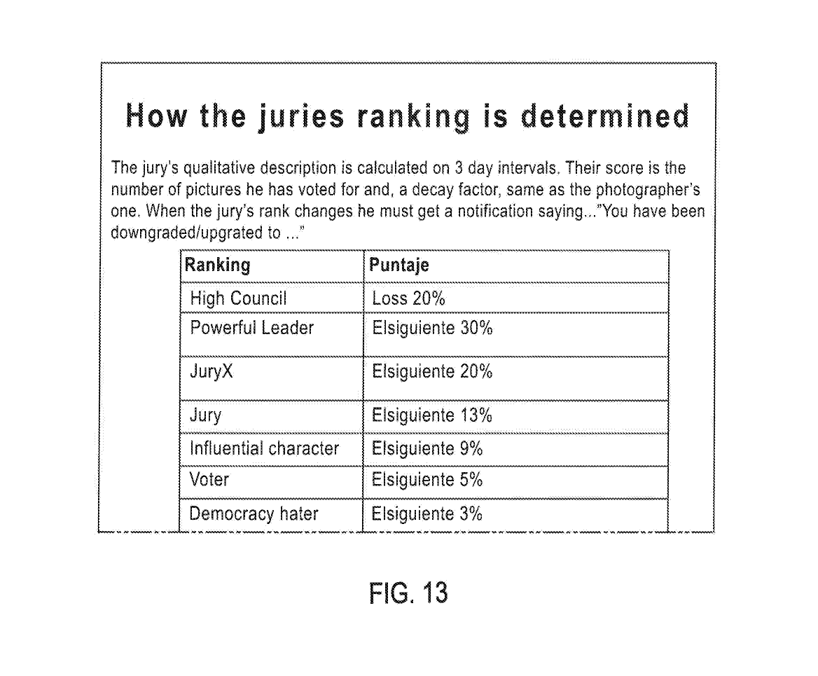

In one embodiment a jury's qualitative description is calculated on three day intervals. Their score is the number of photographs that the participant has voted for and, a decay factor that is the same as the photographer's is used. When the jury's rank changes the photographer receives a notice is this change, see FIG. 13.

### Cloud Infrastructure

FIGS. 14-(a) through (e) illustrate the Cloud Infrastructure used with the preceding.

Turning to the FIGS. 14(a) through (e), one embodiment of a cloud based system 110 is illustrated.

In one embodiment, the elements of the cloud assign for every photograph that is directly correlated to the number of votes it has received, the number of times it has been saved, shared or screenshot, the number of visits to the uploader's profile it has generated and the number of flips people have given it, and that is inversely correlated to the number of times it has been displayed. These scores are in a set D. In another set, R, there are several probability values in a probability distribution, all of which add up to 1 (100%). Both sets D and R are ordered, from the biggest element to the smallest. An ordering embedded function is performed (a function that preserves the orders on both sets) from R to D. The elements that are assigned probabilities have that probability of appearing in the stream when a user is on the app. The system 110 includes a third party service provider 120, that is provided by the methods used with the present invention, that can concurrently service requests from several clients without user perception of degraded computing performance as compared to conventional techniques where computational tasks can be performed upon a client or a server within a proprietary intranet. The third party service provider 120 (e.g., “cloud”) supports a collection of hardware and/or software resources 122. The hardware and/or software resources 122 can be maintained by an off-premises party, and the resources 122 can be accessed and utilized by identified users over Network Systems. Resources 122 provided by the third party service provider 120 can be centrally located and/or distributed at various geographic locations. For example, the third party service provider 120 can include any number of data center machines that provide resources 122 that execute the various mathematical calculations. The data center machines can be utilized for storing/retrieving data, effectuating computational tasks, rendering graphical outputs, routing data, and so forth.

In one embodiment, the third party service provider 120 can provide any number of resources 122 such as data storage services, computational services, word processing services, electronic mail services, presentation services, spreadsheet services, gaming services, web syndication services (e.g., subscribing to a RSS feed), and any other services or applications that are conventionally associated with personal computers and/or local servers. Further, utilization of any number of third party service providers similar to the third party service provider 120 is contemplated. The preceding is used to execute the mathematical calculations set forth in the above algorithms. According to an illustration, disparate third party service providers can be maintained by differing off-premise parties and a user can employ, concurrently, at different times, and the like, all or a subset of the third party service providers.

By leveraging resources 122 supported by the third party service provider 120, limitations commonly encountered with respect to hardware associated with clients and servers within proprietary intranets can be mitigated. Off-premises parties, instead of users of clients or network administrators of servers within proprietary intranets, can maintain, troubleshoot, replace and update the hardware resources 122. Further, for example, lengthy downtimes can be mitigated by the third party service provider 120 utilizing redundant resources 122; thus, if a subset of the resources 122 are being updated or replaced, the remainder of the resources 122 can be utilized to service requests from users. According to this example, the resources 122 can be modular in nature, and thus, resources 122 can be added, removed, tested, modified, etc. while the remainder of the resources 122 can support servicing user requests. Moreover, hardware resources 122 supported by the third party service provider 120 can encounter fewer constraints with respect to storage, processing power, security, bandwidth, redundancy, graphical display rendering capabilities, etc. as compared to conventional hardware associated with clients and servers within proprietary intranets.

The system 110 can include a mobile device, client device 124 that employs resources 122 of the third party service provider 120. Although one client device 124 is depicted, it is to be appreciated that the system 100 can include any number of client devices similar to the client device 124, and the plurality of client devices can concurrently utilize supported resources 122. By way of illustration, the client device 124 can be a desktop device (e.g., personal computer), mobile device, and the like. Further, the client device 124 can be an embedded system that can be physically limited, and hence, it can be beneficial to leverage resources 122 of the third party service provider 120.

Resources 122 can be shared amongst a plurality of client devices subscribing to the third party service provider 120. According to an illustration, one of the resources 122 can be at least one central processing unit (CPU), where CPU cycles can be employed to effectuate computational tasks requested by the client device 124. The CPU is used to execute the mathematical calculations described above. Pursuant to this illustration, the client device 124 can be allocated a subset of an overall total number of CPU cycles, while the remainder of the CPU cycles can be allocated to disparate client device(s). Additionally or alternatively, the subset of the overall total number of CPU cycles allocated to the client device 124 can vary over time. Further, a number of CPU cycles can be purchased by the user of the client device 124. In accordance with another example, the resources 122 can include data store(s) that can be employed by the client device 124 to retain data. The user employing the client device 124 can have access to a portion of the data store(s) supported by the third party service provider 120, while access can be denied to remaining portions of the data store(s) (e.g., the data store(s) can selectively mask memory based upon user/device identity, permissions, and the like). It is contemplated that any additional types of resources 122 can likewise be shared.

The third party service provider 120 can further include an interface component 128 that can receive input(s) from the client device 124 and/or enable transferring a response to such input(s) to the client device 124 (as well as perform similar communications with any disparate client devices). According to an example, the input(s) can be request(s), data, executable program(s), etc. For instance, request(s) from the client device 124 can relate to effectuating a computational task, storing/retrieving data, rendering a user interface, and the like via employing one or more resources 122. Further, the interface component 128 can obtain and/or transmit data over Network System. According to an illustration, executable code can be received and/or sent by the interface component 128 over the network connection. Pursuant to another example, a user (e.g. employing the client device 124) can issue commands via the interface component 128.

Moreover, the third party service provider 120 includes a dynamic allocation component 110 that apportions resources 122 (e.g., hardware resource(s)) supported by the third party service provider 120 to process and respond to the input(s) (e.g., request(s), data, executable program(s), . . . ) obtained from the client device 124.

Although the interface component 128 is depicted as being separate from the dynamic allocation component 110, it is contemplated that the dynamic allocation component 110 can include the interface component 128 or a portion thereof. The interface component 128 can provide various adaptors, connectors, channels, communication paths, etc. to enable interaction with the dynamic allocation component 110.

In one embodiment the third party service provider 120 includes: interface component 126 coupled to dynamic allocation component 110. The dynamic allocation component includes a user state evaluator 132, enhancement component 134, and a calculation component 136 in communication with subscription data.

In one embodiment the dynamic allocation component includes a load balancing component 140 that communicates with the voters with various resources 122.

In one embodiment an archive component 144 is used relative to voting and includes a management component, a versioning component 150, a security component 152, a permission component 154, an aggregation component 156, and a restoration component. Data stores 146 are included

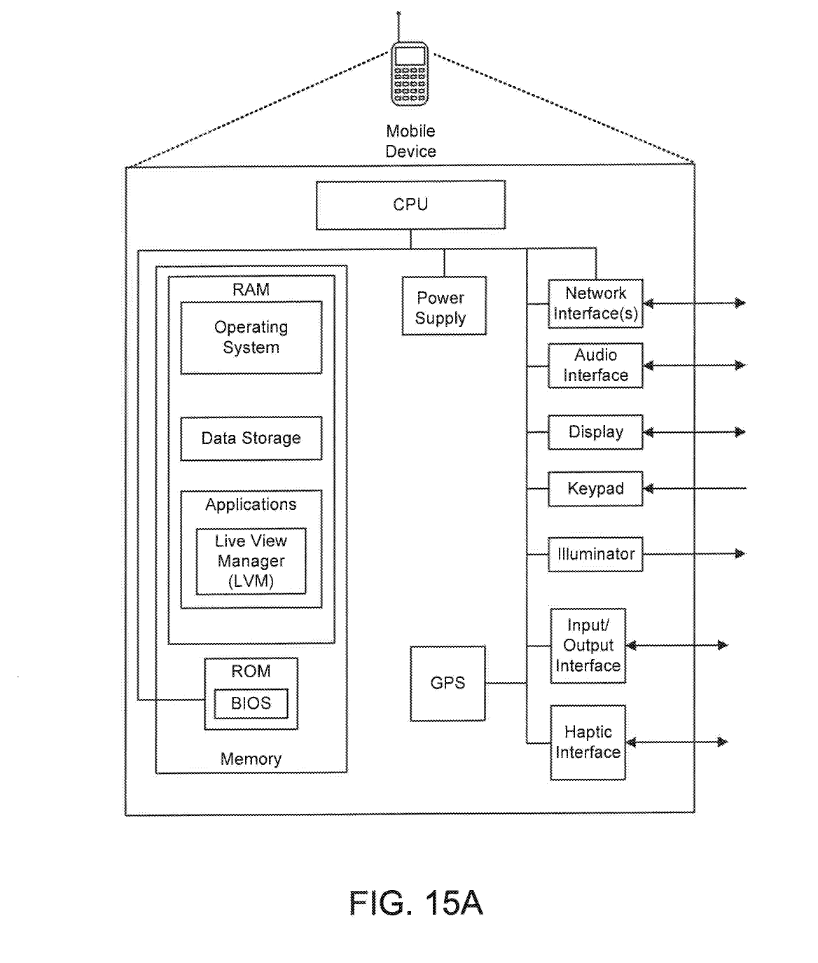

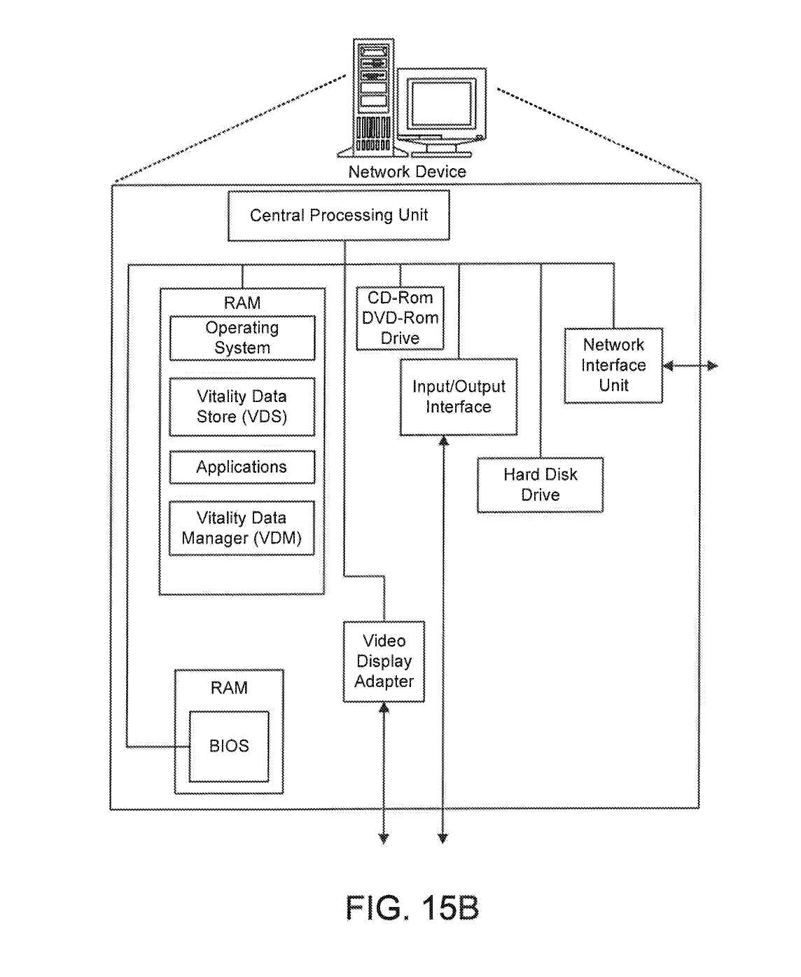

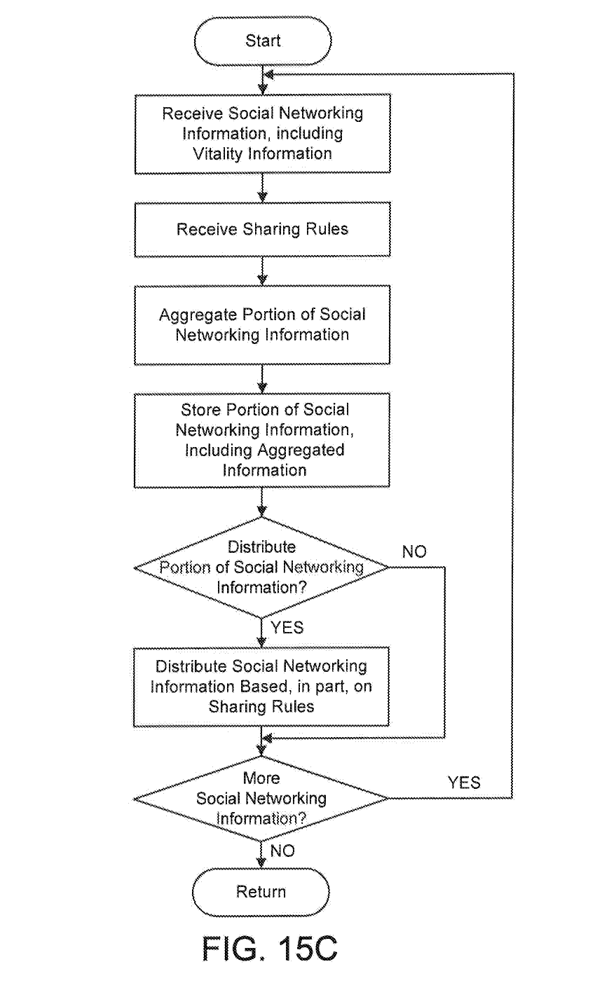

Referring now to FIGS. 15(a) through 15(c) diagrams are provided illustrating embodiments of a mobile or computing device that can be used with the present invention.

The mobile or computing device can include a display that can be a touch sensitive display. The touch-sensitive display is sometimes called a “touch screen” for convenience, and may also be known as or called a touch-sensitive display system. The mobile or computing device may include a memory (which may include one or more computer readable storage mediums), a memory controller, one or more processing units (CPU's), a peripherals interface, Network Systems circuitry, including but not limited to RF circuitry, audio circuitry, a speaker, a microphone, an input/output (I/O) subsystem, other input or control devices, and an external port. The mobile or computing device may include one or more optical sensors. These components may communicate over one or more communication buses or signal lines.

It should be appreciated that the mobile or computing device is only one example of a portable multifunction mobile or computing device, and that the mobile or computing device may have more or fewer components than shown, may combine two or more components, or a may have a different configuration or arrangement of the components. The various components may be implemented in hardware, software or a combination of hardware and software, including one or more signal processing and/or application specific integrated circuits.

Memory may include high-speed random access memory and may also include non-volatile memory, such as one or more magnetic disk storage devices, flash memory devices, or other non-volatile solid-state memory devices. Access to memory by other components of the mobile or computing device, such as the CPU and the peripherals interface, may be controlled by the memory controller.

The peripherals interface couples the input and output peripherals of the device to the CPU and memory. The one or more processors run or execute various software programs and/or sets of instructions stored in memory to perform various functions for the mobile or computing device and to process data.

In some embodiments, the peripherals interface, the CPU, and the memory controller may be implemented on a single chip, such as a chip. In some other embodiments, they may be implemented on separate chips.

The Network System circuitry receives and sends signals, including but not limited to RF, also called electromagnetic signals. The Network System circuitry converts electrical signals to/from electromagnetic signals and communicates with communications Network Systems and other communications devices via the electromagnetic signals. The Network Systems circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The Network Systems circuitry may communicate with Network Systems and other devices by wireless communication.

The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), BLUETOOTH®, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry, the speaker, and the microphone provide an audio interface between a user and the mobile or computing device. The audio circuitry receives audio data from the peripherals interface, converts the audio data to an electrical signal, and transmits the electrical signal to the speaker. The speaker converts the electrical signal to human-audible sound waves. The audio circuitry also receives electrical signals converted by the microphone from sound waves. The audio circuitry converts the electrical signal to audio data and transmits the audio data to the peripherals interface for processing. Audio data may be retrieved from and/or transmitted to memory and/or the Network Systems circuitry by the peripherals interface. In some embodiments, the audio circuitry also includes a headset jack. The headset jack provides an interface between the audio circuitry and removable audio input/output peripherals, such as output-only headphones or a headset with both output (e.g., a headphone for one or both ears) and input (e.g., a microphone).

The I/O subsystem couples input/output peripherals on the mobile or computing device, such as the touch screen and other input/control devices, to the peripherals interface. The I/O subsystem may include a display controller and one or more input controllers for other input or control devices. The one or more input controllers receive/send electrical signals from/to other input or control devices. The other input/control devices may include physical buttons (e.g., push buttons, rocker buttons, etc.), dials, slider switches, and joysticks, click wheels, and so forth. In some alternate embodiments, input controller(s) may be coupled to any (or none) of the following: a keyboard, infrared port, USB port, and a pointer device such as a mouse. The one or more buttons may include an up/down button for volume control of the speaker and/or the microphone. The one or more buttons may include a push button. A quick press of the push button may disengage a lock of the touch screen or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button may turn power to the mobile or computing device on or off. The user may be able to customize a functionality of one or more of the buttons. The touch screen is used to implement virtual or soft buttons and one or more soft keyboards.

The touch-sensitive touch screen provides an input interface and an output interface between the device and a user. The display controller receives and/or sends electrical signals from/to the touch screen. The touch screen displays visual output to the user. The visual output may include graphics, text, icons, video, and any combination thereof (collectively termed “graphics”). In some embodiments, some or all of the visual output may correspond to user-interface objects, further details of which are described below.

A touch screen has a touch-sensitive surface, sensor or set of sensors that accepts input from the user based on haptic and/or tactile contact. The touch screen and the display controller (along with any associated modules and/or sets of instructions in memory) detect contact (and any movement or breaking of the contact) on the touch screen and converts the detected contact into interaction with user-interface objects (e.g., one or more soft keys, icons, web pages or images) that are displayed on the touch screen. In an exemplary embodiment, a point of contact between a touch screen and the user corresponds to a finger of the user.

The touch screen may use LCD (liquid crystal display) technology, or LPD (light emitting polymer display) technology, although other display technologies may be used in other embodiments. The touch screen and the display controller may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen.

A touch-sensitive display in some embodiments of the touch screen may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in their entirety. However, a touch screen displays visual output from the portable mobile or computing device, whereas touch sensitive tablets do not provide visual output.

A touch-sensitive display in some embodiments of the touch screen may be as described in the following applications: (1) U.S. patent application Ser. No. 11/381,313, “Multipoint Touch Surface Controller,” filed May 12, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen may have a resolution in excess of 1000 dpi. In an exemplary embodiment, the touch screen has a resolution of approximately 1060 dpi. The user may make contact with the touch screen using any suitable object or appendage, such as a stylus, a finger, and so forth. In some embodiments, the user interface is designed to work primarily with finger-based contacts and facial expressions, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the mobile or computing device may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen or an extension of the touch-sensitive surface formed by the touch screen.

In some embodiments, the mobile or computing device may include a physical or virtual click wheel as an input control device. A user may navigate among and interact with one or more graphical objects (henceforth referred to as icons) displayed in the touch screen by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller as well as one or more of the modules and/or sets of instructions in memory. For a virtual click wheel, the click wheel and click wheel controller may be part of the touch screen and the display controller, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

The mobile or computing device also includes a power system for powering the various components. The power system may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The mobile or computing device may also include one or more sensors, including not limited to optical sensors. In one embodiment an optical sensor is coupled to an optical sensor controller in I/O subsystem. The optical sensor may include charge-coupled device (CCD) or complementary metal-oxide semiconductor (CMOS) phototransistors. The optical sensor receives light from the environment, projected through one or more lens, and converts the light to data representing an image. In conjunction with an imaging module (also called a camera module); the optical sensor may capture still images or video. In some embodiments, an optical sensor is located on the back of the mobile or computing device, opposite the touch screen display on the front of the device, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor can be changed by the user (e.g., by rotating the lens and the sensor in the device housing) so that a single optical sensor may be used along with the touch screen display for both video conferencing and still and/or video image acquisition.

The mobile or computing device may also include one or more proximity sensors. In one embodiment, the proximity sensor is coupled to the peripherals interface. Alternately, the proximity sensor may be coupled to an input controller in the I/O subsystem. The proximity sensor may perform as described in U.S. patent application Ser. No. 11/241,839, “Proximity Detector In Handheld Device,” filed Sep. 30, 2005; Ser. No. 11/240,788, “Proximity Detector In Handheld Device,” filed Sep. 30, 2005; Ser. No. 13/096,386, “Using Ambient Light Sensor To Augment Proximity Sensor Output”; Ser. No. 13/096,386, “Automated Response To And Sensing Of User Activity In Portable Devices,” filed Oct. 24, 2006; and Ser. No. 11/638,251, “Methods And Systems For Automatic Configuration Of Peripherals,” which are hereby incorporated by reference in their entirety. In some embodiments, the proximity sensor turns off and disables the touch screen when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

In some embodiments, the software components stored in memory may include an operating system, a communication module (or set of instructions), a contact/motion module (or set of instructions), a graphics module (or set of instructions), a text input module (or set of instructions), a Global Positioning System (GPS) module (or set of instructions), and applications (or set of instructions).

The operating system (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module facilitates communication with other devices over one or more external ports and also includes various software components for handling data received by the Network Systems circuitry and/or the external port. The external port (e.g., Universal Serial Bus (USB), FIREWIRE, etc.) is adapted for coupling directly to other devices or indirectly over Network System. In some embodiments, the external port is a multi-pin (e.g., 30-pin) connector that is the same as, or similar to and/or compatible with the 30-pin connector used on iPod (trademark of Apple Computer, Inc.) devices.

The contact/motion module may detect contact with the touch screen (in conjunction with the display controller) and other touch sensitive devices (e.g., a touchpad or physical click wheel). The contact/motion module includes various software components for performing various operations related to detection of contact, such as determining if contact has occurred, determining if there is movement of the contact and tracking the movement across the touch screen, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module and the display controller also detect contact on a touchpad. In some embodiments, the contact/motion module and the controller detects contact on a click wheel.

Examples of other applications that may be stored in memory include other word processing applications, JAVA-enabled applications, encryption, digital rights management, voice recognition, and voice replication.

In conjunction with touch screen, display controller, contact module, graphics module, and text input module, a contacts module may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone, video conference, e-mail, or IM; and so forth.

In one embodiment social networks are utilized with the ranking.

100 becomes 200

200 becomes 300

300 becomes 400

500 becomes 600

FIG. 16 shows components of one embodiment of an environment in which the invention may be practiced. Not all the components may be required to practice the invention, and variations in the arrangement and type of the components may be made without departing from the spirit or scope of the invention. As shown, system 200 of FIG. 16 includes Network System 210, Vitality Aggregation Service (VAS) 206, mobile devices (client devices) 202-204, client device 201, and information services 207.

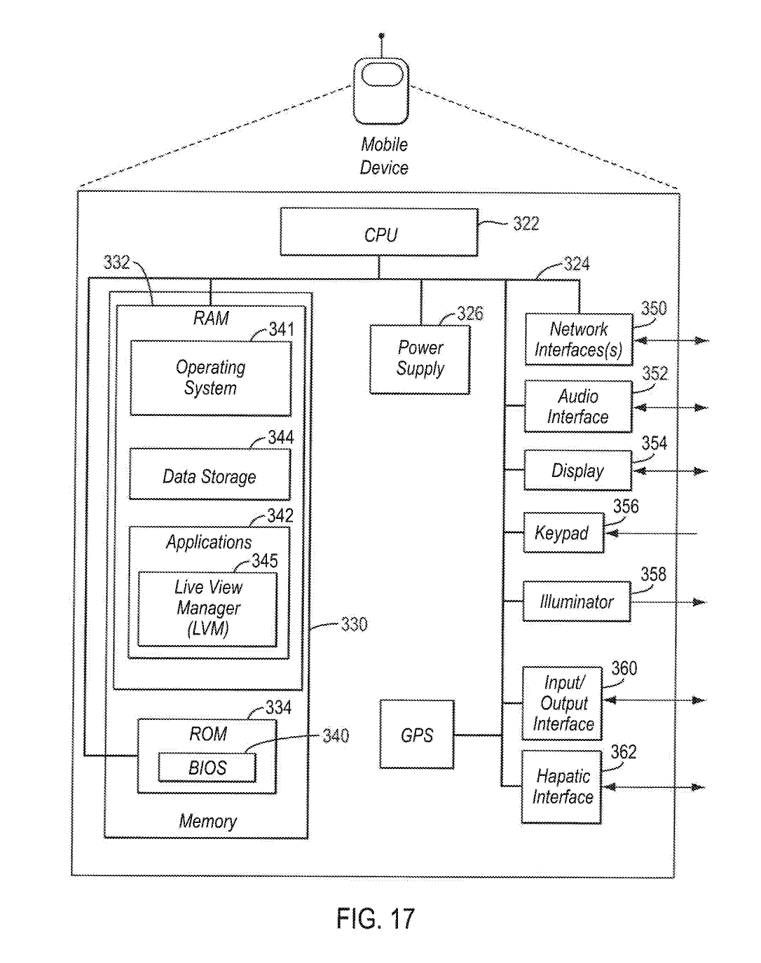

One embodiment of mobile devices 202-203 are described above in FIGS. 15A-15C and below in conjunction with FIG. 17. Generally, however, mobile devices 202-204 may include virtually any portable computing device capable of receiving and sending a message over a network, such as network 105, Network System 210, or the like.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 202-204 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 202-204 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to VAS 206, client device 201, or other computing devices.

Mobile devices 202-204 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as VAS 206, client device 201, or the like. However, the present invention is not limited to these message protocols, and virtually any other message protocol may be employed.

Mobile devices 202-204 may be further configured to enable a user to participate in communications sessions, such as IM sessions. As such, mobile devices 202-204 may include a client application that is configured to manage various actions on behalf of the client device. For example, the client application may enable a user to interact with the browser application, email application, IM applications, SMS application, and the like.

Mobile devices 202-204 may further be configured to include a client application that enables the end-user to log into an end-user account that may be managed by another computing device, such as VAS 206. Such end-user account, for example, may be configured to enable the end-user to receive emails, send/receive IM messages, SMS messages, and access selected web pages, participate in a social networking activity, or the like. However, participation in various social networking activities may also be performed without logging into the end-user account.

In addition, mobile devices 202-204 may include another application that is configured to enable the mobile user to display and interact with various integrated live views that are configured based, in part, on the mobile user's social networking activities, experiences, and the like, including vitality information associated with the mobile user's social network. The integrated live views may be directed towards providing the mobile user with a virtual ‘hang-out’ space for participating in various social events, including but not limited to sending/receiving photos between social networking members, ‘chit-chatting’ with members, blogging, sharing visual mood representations, sharing various messages, and generally participating in a variety of integrated social experiences beyond merely voice communications or text messages (e.g., IM). Moreover, such integrated live views enable the mobile user to configure highly personalized views and identities in virtual spaces within their social network.

Mobile devices 202-204 may also communicate with non-mobile client devices, such as client device 201, or the like. In one embodiment, such communications may include participation in social networking activities, including sharing of photographs, participating in determining how to spend time with other members, sending/receiving of messages, providing information based on physical proximity between members, or similar virtual hang-out activities.

Client device 201 may include virtually any computing device capable of communicating over a network to send and receive information, including social networking information, or the like. The set of such devices may include devices that typically connect using a wired or wireless communications medium such as personal computers, multiprocessor systems, microprocessor-based or programmable consumer electronics, network PCs, or the like.

Network System 210 is configured to couple mobile devices 202-204 and its components with any Network System 210.

In one embodiment Network System 210 may further include an autonomous system of terminals, gateways, routers, and the like connected by wireless radio links, and the like. These connectors may be configured to move freely and randomly and organize themselves arbitrarily, such that the topology of Network System 210 may change rapidly.

Network System 210 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 202-204 with various degrees of mobility.

In one embodiment Network System 210 is configured to couple VAS 206 and its components with other computing devices, including, mobile devices 202-204, client device 201, and through Network System 210 to mobile devices 202-204. Network System 210 is enabled to employ any form of computer readable media for communicating information from one electronic device to another. Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

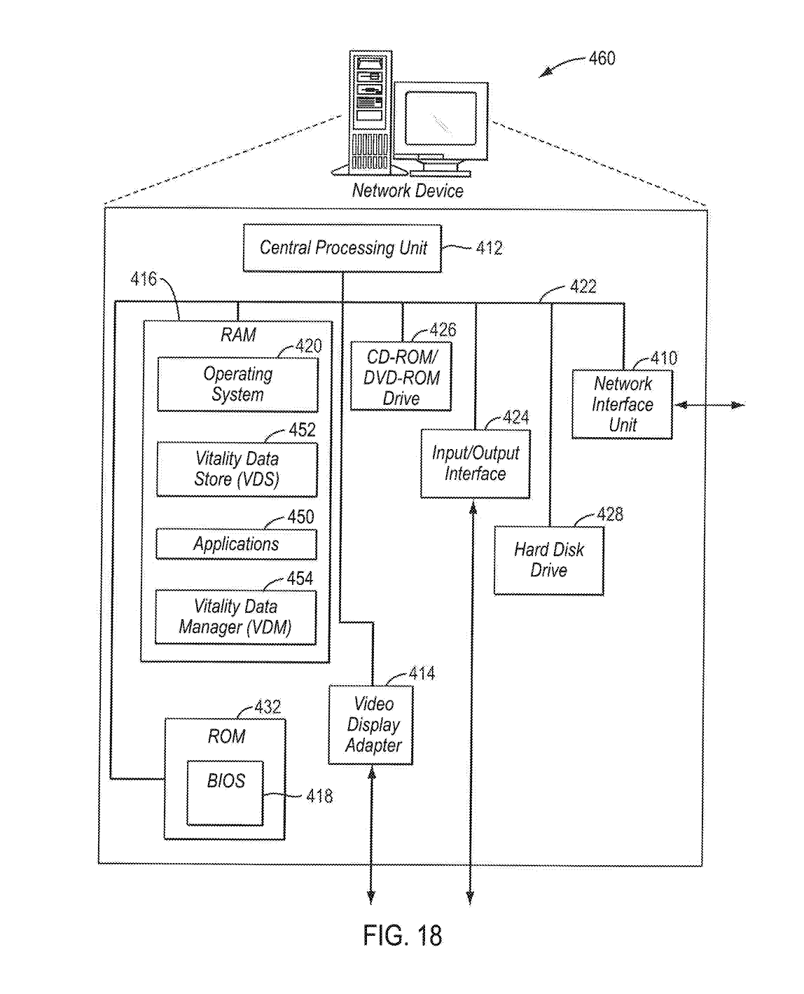

One embodiment of VAS 206 is described in more detail below in conjunction with FIG. 18. Briefly, however, VAS 206 may include any computing device capable of connecting to network 205 to enable aggregation and management of social networking information, including vitality information. VAS 206 may receive from various participants in a social network, information including information associated with activities, moods, events, messages, vitality information, communications, or the like. VAS 206 may also receive social networking information from a variety of other sources including, for example, information services 107. VAS 206 may store at least some of the received information for use by one or more social networking members. VAS 206 may also aggregate a portion of the received social networking information and enable one or more social networking members to receive and/or use at least a portion of the aggregated information.

Devices that may operate as VAS 206 include personal computers desktop computers, multiprocessor systems, microprocessor-based or programmable consumer electronics, network PCs, servers, and the like.

Although FIG. 16 illustrates VAS 206 as a single computing device, the invention is not so limited. For example, one or more functions of VAS 206 may be distributed across one or more distinct computing devices. For example, managing various social networking activities, including sharing of photographs, managing Instant Messaging (IM) session, SMS messages, email messages, sharing of contact information, aggregating and/or storing of social networking information, or the like, may be performed by a plurality of computing devices, without departing from the scope or spirit of the present invention.

Information services 207 represents a variety of service devices that may provide additional information for use in generating integrated live views on mobile devices 202-204. Such services include, but are not limited to web services, third-party services, audio services, video services, email services, IM services, SMS services, VOIP services, calendaring services, photograph services, or the like. Devices that may operate as information services 107 include personal computers desktop computers, multiprocessor systems, microprocessor-based or programmable consumer electronics, network PCs, servers, and the like.

FIG. 2 shows one embodiment of mobile device that may be included in a system implementing the invention. Mobile device may include many more or less components than those shown in FIG. 17. However, the components shown are sufficient to disclose an illustrative embodiment for practicing the present invention. Mobile device may represent, for example, mobile devices 202-204 of FIG. 16.

In one embodiment, illustrated in FIG. 2, mobile device can includes a processing unit (CPU) 322 in communication with a mass memory 330 via a bus 324. Mobile device also includes a power supply 326, one or more network interfaces 350, an audio interface 352, a display 354, a keypad 356, an illuminator 358, an input/output interface 360, a haptic interface 362, and an optional global positioning systems (GPS) receiver 364. Power supply 326 provides power to mobile device. A rechargeable or non-rechargeable battery may be used to provide power. The power may also be provided by an external power source, such as an AC adapter or a powered docking cradle that supplements and/or recharges a battery.

Mobile device may optionally communicate with a base station (not shown), or directly with another computing device. Network interface 350 includes circuitry for coupling mobile device to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 350 is sometimes known as a transceiver, transceiving device, or network interface card (NIC).

Audio interface 352 is arranged to produce and receive audio signals such as the sound of a human voice. For example, audio interface 352 may be coupled to a speaker and microphone (not shown) to enable telecommunication with others and/or generate an audio acknowledgement for some action. Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand.

In one embodiment mobile device includes input/output interface 360 for communicating with external devices, such as a headset, or other input or output devices not shown in FIG. 17. Input/output interface 360 can utilize one or more communication technologies, such as USB, infrared, Bluetooth™, or the like. Haptic interface 362 is arranged to provide tactile feedback to a user of the client device. For example, the haptic interface may be employed to vibrate mobile device in a particular way when another user of a computing device is calling.

Optional GPS transceiver 364 can determine the physical coordinates of mobile device on the surface of the Earth, which typically outputs a location as latitude and longitude values. GPS transceiver 364 can also employ other geo-positioning mechanisms, including, but not limited to, triangulation, assisted GPS (AGPS), E-OTD, CI, SAI, ETA, BSS or the like, to further determine the physical location of mobile device on the surface of the Earth. It is understood that under different conditions, GPS transceiver 364 can determine a physical location within millimeters for mobile device; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

In one embodiment mass memory 330 includes a RAM 232, a ROM 234, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of mobile device. The mass memory also stores an operating system 341 for controlling the operation of mobile device. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 330 further includes one or more data storage 344, which can be utilized by mobile device to store, among other things, applications 342 and/or other data. For example, data storage 344 may also be employed to store information that describes various capabilities of mobile device. The information may then be provided to another device based on any of a variety of events, including being sent as part of a header during a communication, sent upon request, or the like. Moreover, data storage 344 may also be employed to store social networking information including vitality information, or the like. At least a portion of the social networking information may also be stored on a disk drive or other storage medium (not shown) within mobile device.

Applications 342 may include computer executable instructions which, when executed by mobile device, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 342 may further include live view manager (LVM) 345.

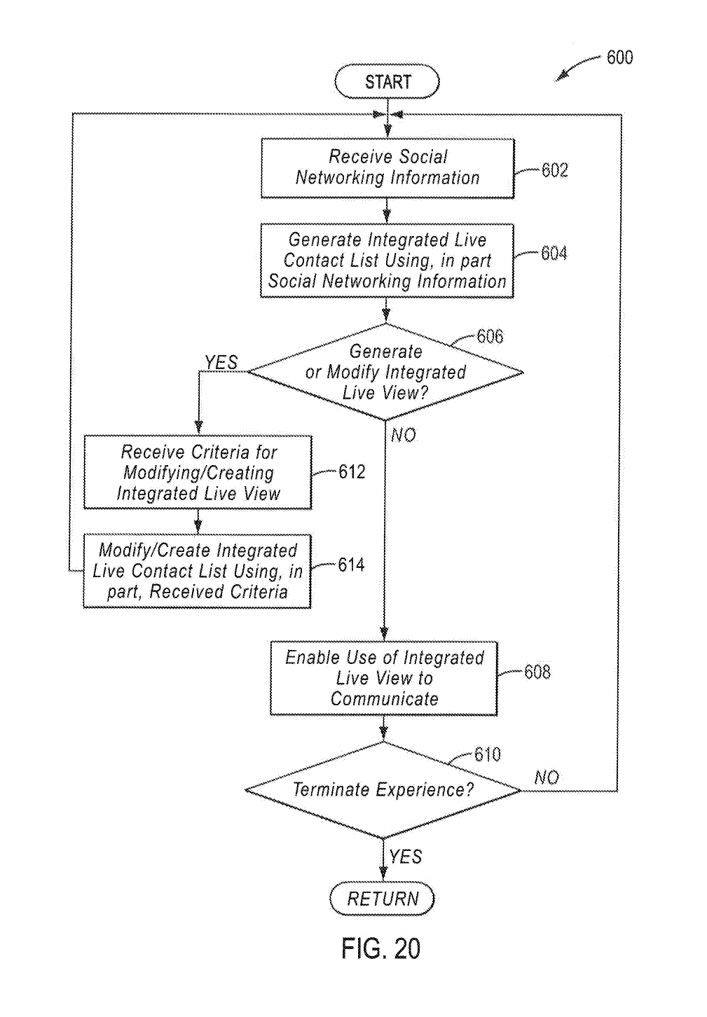

LVM 345 may be configured to receive and enable a display of integrated live views into a social network member's activities. For example, one embodiment of an integrated live view includes a live contact list that integrates a contact's social activities including IM status, SMS status, email status, photographs, blog updates, RSS feeds, recent messages, icons or other visual representations, mood indicators, and the like. LVM 345 further enables the user of mobile device to select different integrated live views including, but not limited to integrated live views based on a social networking relationship such as friends, degrees of separation, activities, work relationships, family relationships, or the like. In one embodiment, LVM 345 enables the user to sort a list of displayed contacts based on a variety of criteria, including but not limited to current online activities, moods, messages, member relationships, physical proximity to other members (at indicated by their client device), or the like. Various embodiments of integrated live views are described in more detail below in conjunction with FIGS. 6-9. Moreover, LVM 345 may employ a process substantially similar to that described below in conjunction with FIG. 20.

Illustrative Server Environment

FIG. 18 shows one embodiment of a network device, according to one embodiment of the invention. Network device 400 may include many more components than those shown. The components shown, however, are sufficient to disclose an illustrative embodiment for practicing the invention. Network device 400 may represent, for example, VAS 206 of FIG. 16.

Network device 400 includes processing unit 412, video display adapter 314, an input/output interface 460, and a mass memory, all in communication with each other via bus 422. The mass memory generally includes RAM 416, ROM 332, and one or more permanent mass storage devices, such as hard disk drive 428, tape drive, optical drive CD-ROM/DVD-ROM 426, and/or floppy disk drive. The mass memory stores operating system 420 for controlling the operation of network device 400. Any general purpose operating system may be employed. Basic input/output system (“BIOS”) 418 is also provided for controlling the low level operation of network device 400. As illustrated in FIG. 18, network device 400 also can communicate with the Internet, or some other communications network, via network interface unit 310, which is constructed for use with various communication protocols including the TCP/IP protocol. Network interface unit 410 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 450 are loaded into mass memory and run on operating system 420. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Vitality Data Manager (VDM) 354 may also be included as an application program within applications 450.

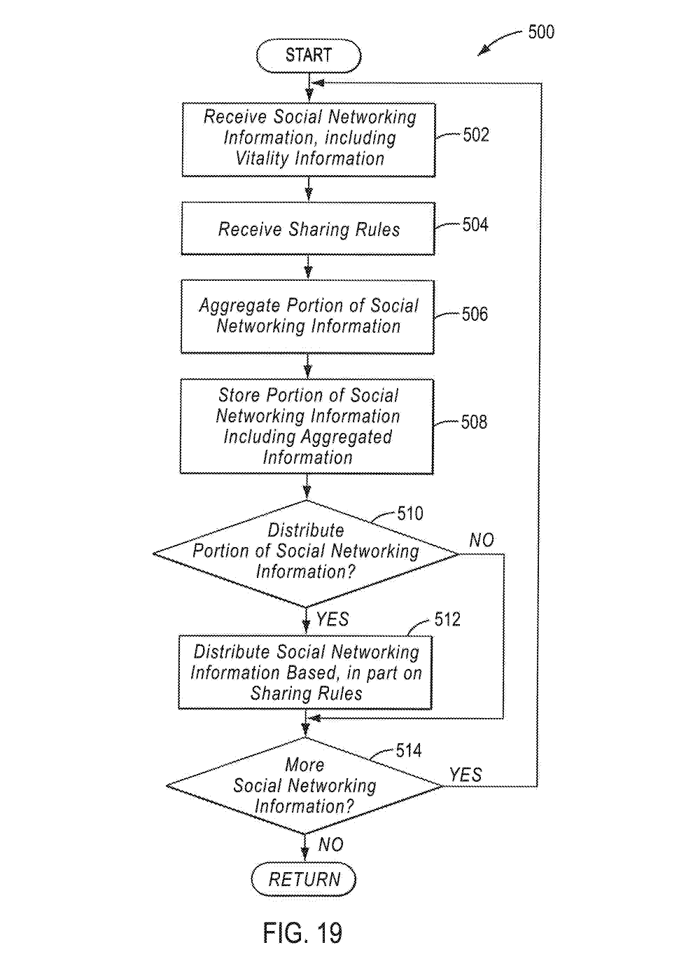

VDM 454 is configured to receive from a variety of sources information that may be associated with social networking activities of various social networking members. Such information may include but is not limited to various communications, including emails, SMS messages, IM messages, audio messages, VOIP messages, RSS feeds, membership information, calendar events, photograph streams, photographs, blog updates, web pages, mood information, behaviors of social network members, or the like. VDM 454 may aggregate or otherwise combine at least some of the received information to generate aggregate vitality information such as a mood of a group, organization, or the like, group events, albums, aggregate music selections, tags, or the like. VDM 454 may store at least some of the received and/or aggregated information in Vitality Data Store (VDS) 452, which may be implemented as a database, a folder, program, or the like. VDM 454 may also distribute at least some of the received and/or aggregated information to one or more social networking members, such as mobile devices 202-204 and/or client device 201 of FIG. 16 or the like. VDM 454 may employ a process substantially similar to that described below in conjunction with FIG. 19.

Generalized Operation

FIG. 19 illustrates a logical flow diagram generally showing one embodiment of a process for managing social networking information, including vitality information for social networking members. Process 500 of FIG. 19 may be implemented within VAS 206 of FIG. 16.

Process 500 begins, after a start block, at block 502, where social networking information, including vitality information is received from a variety of sources. In one embodiment, the social networking information may be received from a plurality of mobile devices, RSS services, IM services, email services, VOIP services, audio services, web services, graphics services, or the like. For example, a social networking member may provide a mood avatar, photograph, or information from a blog. In another example, a web service, or other service may provide photographs, audio files, or the like. In one embodiment, information may be received, absent a solicitation for the information. In another embodiment, a request for information may be sent to various services, mobile devices, client devices, or the like. The received information may include various vitality information including, but not limited to mood information, location information, IM or other communication status, information indicating a change in a blog status, or any of the other vitality information described above.

Processing then flows to block 404 where sharing rules are received. In one embodiment, a sending device may also employ sharing rules to determine whether to send particular vitality information. For example, a mobile user, or the like, may elect not to communicate their physical location. Therefore, such information might not be received for some social networking members. In another embodiment, sharing rules may be received prior to or even coincident with some portion of social networking information. For example, in one embodiment, a photograph sharing service may send a selection of photographs, or the like, with sharing rules that indicate whether a social networking member may receive or otherwise access one or more of the photographs. Such sharing rules therefore, indicate which social networking member(s) may receive or otherwise access which portion of social networking information. Thus, sharing rules include various criteria, events, triggers, permissions, or the like.

Process 500 then flows to block 506 where based in part on the sharing rules, at least some of the received social networking information, including at least some of the vitality information may be aggregated, or otherwise combined. For example, where a predefined group of social networking members provide a mood identifier that indicates a similar mood, an aggregated mood might be generated for the group. As another example, where several social networking members have provided an opinion on a blog, a restaurant, an event, or the like, an aggregated opinion may be generated. Clearly, the invention, however, is not limited to these examples, and a variety of other received social networking information may be aggregated, without departing from the scope or spirit of the invention.

Processing then flows to block 508, where at least some of the received social networking information, including vitality information, and aggregated information may be stored. Storage of such information enables distribution at some other time, additional aggregation, and/or other analysis to be performed, or the like. However, storage of social networking information may be, in at least one embodiment, optional.

Flowing next to decision block 510, a determination is made whether to distribute at least a portion of the social networking information. Distribution may be performed based on a variety of criteria, including but not limited to, sending the information as soon as it is received, sending at least some of the information based on an event, time, or the like. For example, in one embodiment, some of the information may be distributed in real-time, while other information may be distributed based on an event, or the like. In any event, if distribution of social networking information is to occur, processing flows to block 512; otherwise, processing flows to decision block 514.

At block 512, the social networking information, including at least some aggregation information, is distributed to at least one mobile device, based on the received sharing rules. Processing then flows to decision block 514.

At decision block 514, a determination is made whether there is more social networking information to manage. If there is more social networking information to manage, processing branches back to block 502; otherwise, processing returns to a calling process to perform other actions.

FIG. 20 illustrates a logical flow diagram generally showing one embodiment of a process for enabling a mobile device to employ a virtual hang-out space using integrated live views of a social network member's activities based, at least in part, on vitality information. Process 600 of FIG. 20 may be implemented, for example, within one of mobile devices 202-204 of FIG. 16.

Process 600 begins, after a start block, at block 602, where the mobile device receives various social networking information based in part on various sharing rules. In one embodiment, some of the information may be received in real-time, including such as IM messages, audio communications, or the like.

Processing flows next to block 604 where the mobile device employs the social networking information to generate, and/or update an integrated live contact list. The integrated live contact list may be generated based on a default configuration, and/or based, at least in part, on any user customization of the display. Thus, while an integrated live contact list may display a list of contacts within the mobile user's contact list, it may display the list based on a variety of criteria. For example, the mobile user may elect to have the integrated live contact list be ordered based on whether the contact is currently in an active IM session, whether the contact is within a predetermined physical proximity to the mobile user, or the like. In one embodiment, the integrated live contact list may be organized based on some other grouping, including whether the contact is a family member, a friend, a worker, a member of a predefined activity, of the like.

Process 600 flows next to decision block 606, where a determination is made whether to modify or otherwise generate another integrated live view of contact information. If a modification or generation of another integrated live view is to be performed, processing flows to block 612; otherwise, processing continues to block 608.

At block 612, the mobile user may provide to the mobile device various criteria for organizing another integrated live view, including those suggested above. However, the invention is not limited to these examples, and any of a variety of other criteria may be employed to organize or otherwise create a unique integrated live view of contacts that may be personalized to a mobile user. For example, the mobile user may elect to organize the contact list based on the contact's current mood, blog activity, or the like. In any event, processing flows next to block 614, where the received criteria are employed to generate another integrated live view. In one embodiment, the generated integrated live view may be in addition to the integrated live contact list employed at block 604. In one embodiment, the generated integrated live view may replace the integrated live contact list employed at block 604, such that only a single integrated live view is available to the mobile user. In any event, processing loops back to block 602 to continue the process.

At block 608, however, the integrated live views displayed to the mobile user may be employed to enable the mobile user to perform a variety of communication activities. By integrating various social networking activities into the live view, the mobile user is provided with a more personal and useful perspective of their social network,

Processing flows next to decision block 610, where a determination is made whether the mobile user is to terminate their mobile networking experience. If so, processing returns to a calling block to perform other actions; otherwise, processing loops back to block 602.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

In one embodiment of the present invention systems and methods are provided that where ranking scores are assigned to photographs that are posted. In one embodiment the posting is via Network Systems. In another embodiment the postings are via social media.

In one specific embodiment each photograph has a score that is determined according to a ranking algorithm. The ranking algorithm is used to rank elements in an order, and then assigns probabilities based on any probability distribution.

In one embodiment of the present invention systems and methods are provided that use streaming in the ranking of photography, photographs, in social networks.

The system and method of the present invention allow participants to upload their best photographs and determine what other participants around the world think of them. As a non-limiting example, the present invention can be a system and associated methods in a social networking app. A participant is anyone who downloads the app.

In one embodiment, the participants are both juries and competitors. In one embodiment the photos appear in a stream. Each participant sees and ranks at least a selected number of photographs before uploading one of their own. As a non-limiting example, the number can be three.

In one general aspect, the present invention is directed to computer-based systems and methods that assign ranking scores to photographs that are posted. In one embodiment the posting is via Network Systems. In another embodiment the postings are via social media. Each photograph has a score that is determined according to a ranking algorithm. The ranking algorithm is used to rank elements in an order, and then assigns probabilities based on any probability distribution. The system and method of the present invention allow participants to upload their best photographs and determine what other participants around the world think of them. As a non-limiting example, the present invention can be a system and associated methods in a social networking app. A participant is anyone who downloads the app.

In one embodiment, the participants are both juries and competitors. In one embodiment the photos appear in a stream. Each participant sees and ranks at least a selected number of photographs before uploading one of their own. As a non-limiting example, the number can be three.

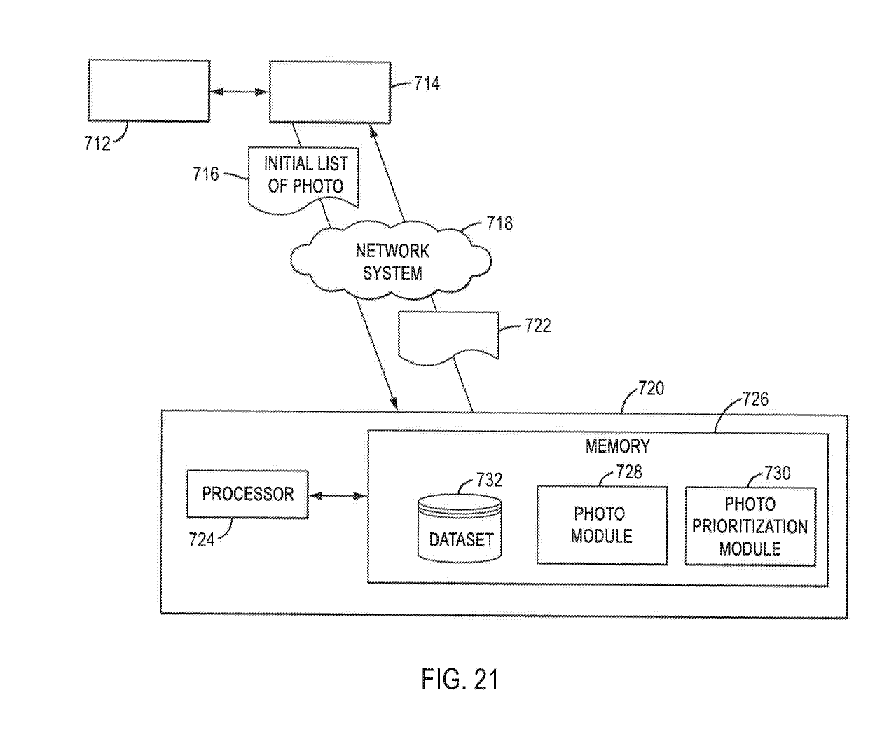

FIG. 21 is a simplified block diagram of an exemplary computer-based system 700 for prioritizing the photographs according to one embodiment of the present invention. In this diagram, photographs 712 are ranked. As shown in FIG. 21, the third party that judge 714 transmits a message, which can be a data file 716, with their vote for the photographs to a prioritization computer system 720 via Network System 718. This data file 716 additionally includes data about the photographs, which the candidate prioritization computer system 720 uses to compute the probabilities.

The photograph prioritization computer system 720 (sometimes referred to herein simply as “computer system 720”) prioritizes the initial list of photographs and transmits a file 722 with the prioritized list of photographs back to a third-party 714 (or other intended party as the case may be) via the data network 718 (or a different data network). The computer system 720 may include at least one processor 724 and at least one memory unit 726 (only one of each is shown in FIG. 21 for the sake of simplicity). The memory 726 may store software that is executed by the processor 724. In particular, the memory 726 may store an algorithm module 728 and a prioritization module 730. The algorithm module 728, when executed by the processor 724, causes the processor 724 to generate the algorithms recited above. The photograph prioritization module 730, when executed by the processor 724, causes the processor 724 to compute the probabilities for the photographs, for the above referenced algorithms, that may also be stored in a database 732 in the memory 726. The memory 726 may be embodied as solid state memory (e.g., ROM), hard disk drive systems, RAID, disk arrays, storage area networks (SANs), and/or any other suitable system for storing computer data and software. In addition, the memory 726 may comprise caches, including web caches and database caches. Parts of the memory 726 may be part of the computer system 720 or connected to the computer system 720 via a network connection (e.g., a LAN).

In various embodiments, an application programming interface (API) is used with the file 716 to transmit the initial list of photographs and related photograph data to the computer system 720.

Further, as described above, at least one of the input variables comprise a social media network variable, such as whether a candidate has a social media network account (e.g., Facebook, twitter, LinkedIn, Google+). The social media network variable may also comprise (additionally or alternatively) an online social media influencer score variable for the photographs, such as the candidates' Klout scores. Also (additionally or alternatively), at least one of the input variables may comprise an external industry variable such as a driving record variable for the photographs. Further, at least one of the input variables (additionally or alternatively) may comprise performance-related variables (e.g., results from a personality traits test, employee work performance evaluation, etc.)

The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, SSDs or hard disk drives. A computer-readable medium may also include memory storage that is physical, virtual, permanent, temporary, semi permanent, and/or semitemporary. A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software and/or data, including a hard disk, an optical disk, floppy disk, ROM (read only memory), RAM (random access memory), PROM (programmable ROM), EEPROM (electrically erasable PROM) and/or other computer-readable media. Further, the various databases described herein may be implemented using, for example, disk storage systems and/or in-memory databases, such as the SAP HANA in-memory database system.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm,” cloud computing environment, or other grouping of networked servers (such as server blades) that are located and configured for cooperative functions. It can be appreciated that a server farm or cloud computing environment may serve to distribute workload between/among individual components of the farm or cloud, as the case may be, and may expedite computing processes by harnessing the collective and cooperative power of multiple servers. Such server farms or clouds may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

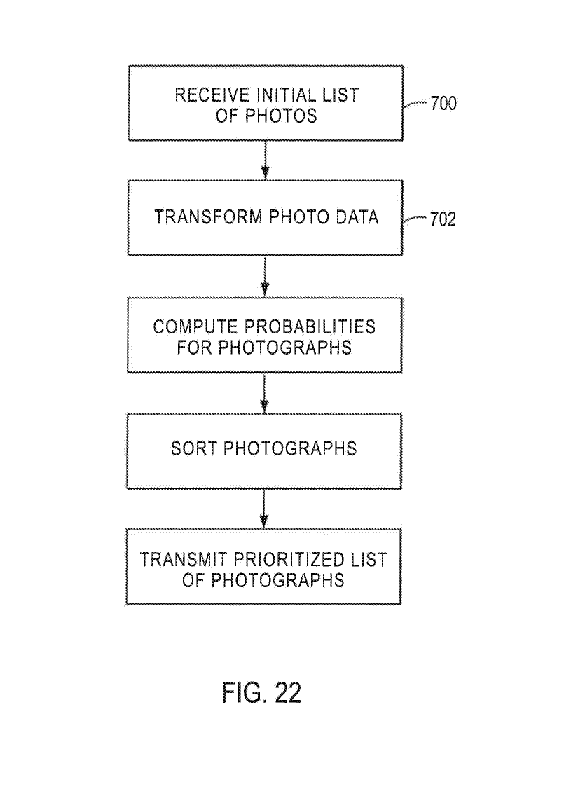

FIG. 22 is a flowchart of a process that the processor 724 may perform, when executing the code of the candidate prioritization module 730, according to various embodiments of the present invention. At step 800, the computer system 720 receives photographs or votes from third parties and at step 802 the data for the photographs is transformed to a suitable form, and so on.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A method for ranking photographs, comprising:
using least one computer system with at least one processor;
executing a ranking algorithm by the processor;
assign a score for one or more photographs, with the score being correlated to a number of votes that a photograph has received from third party participants;
executing the ranking algorithm to determine at least one of: a number of times a photograph has been saved, shared or screenshot, a number of visits to an uploader's profile the photograph has generated, and a number of flips third parties have given the photograph;
wherein the score for a photograph is inversely correlated to a number of times it has been displayed. The system of claim 1, wherein the computer system in operation is configured to provide a probability that a photograph will appear in a given frame in a stream.

2. The method of claim 1, further comprising:
executing by the computer system a binomial distribution for the photograph with a probability of success.

3. The method of claim 2, wherein the binomial distribution is configured to provide a number of trials equivalent to a position of a last value of 1 in a set D.

4. The method of claim 1, further comprising:
assigning probabilities to photographs after probabilities for a plurality of photographs is calculated.

5. The method of claim 1, further comprising:
assigning a highest score to a photograph that has a highest generated score.

6. The method of claim 1, further comprising:
providing a first screen seen by a participant in response to a participant request.

7. The method of claim 1, further comprising:
communicating with a mobile device of the participant.

8. The method of claim 7, further comprising:
providing a participant with a first screen at the mobile device of the participant.

9. The method of claim 7, further comprising:
using a mobile device of a participant to vote for a photograph.

10. The method of claim 1, wherein each of a photograph is displayed to a participant for a selected amount of time.

11. The method of claim 11, further comprising:
display a photograph for the selected amount of time, with the computer system providing a fadeout of the photograph.

12. The method of claim 1, further comprising:
providing for a streaming of photographs to third party participants.

13. The method of claim 1, further comprising:
providing for one or more commands at a mobile device of a third party participant.

14. The method of claim 13, wherein the commands are selected from at least one of: tapping a touch screen of a mobile device to vote for a photograph; and pressing and holding the touch screen to pause a stream of photographs.

15. The method of claim 1, further comprising:
providing a third party participant a number of votes a photograph has received if the third party has voted for that photograph.

16. The method of claim 1, further comprising:
providing a third party participant with a photograph description screen.

17. The method of claim 1, further comprising:
providing a third party participant with a photograph image description screen.

18. The method of claim 1, further comprising:
providing a third party participant with a profile of a photographer.

19. The method of claim 1, further comprising:
providing a third party participant with an overall quantitative description of a photograph

20. The method of claim 1, further comprising:
provide a third party participant with a menu screen.

21. The method of claim 20, further comprising:
providing advertisements on the menu screen.
